(19) United States
(12) Patent Application Publication
(10) Pub. No.: US 2013/0020511 A1
(43) Pub. Date: Jan. 24, 2013

(54) MIRROR, MIRROR DEVICE, LASER APPARATUS, AND EXTREME ULTRAVIOLET LIGHT GENERATION APPARATUS

(71) Applicants: Hidenobu Kameda, Oyama-shi (JP); Osamu Wakabayashi, Hiratsuka-shi (JP)

(72) Inventors: Hidenobu Kameda, Oyama-shi (JP); Osamu Wakabayashi, Hiratsuka-shi (JP)

(73) Assignee: GIGAPHOTON INC, Tochigi (JP)

(21) Appl. No.: 13/638,002

(22) PCT Filed: Oct. 7, 2011
(86) PCT No.: PCT/IB11/02365

§ 371 Date: Sep. 28, 2012

(30) Foreign Application Priority Data
Oct. 8, 2010 (JP) 2010-228656
Jul. 29, 2011 (JP) 2011-166434

(51) Int. Cl. G02B 7/182; G21K 5/04; H01S 3/04

(52) U.S. Cl. 250/504 R; 359/871; 372/34

(57) ABSTRACT

A mirror includes a mirror base provided with a flow channel through which a heat medium passes for cooling the mirror. The flow channel includes a buffer tank portion for adjusting a flow rate of the heat medium in the flow channel. A reflective film is provided on the mirror base.

### CROSS-REFERENCE TO RELATED APPLICATIONS

The application claims priority of Japanese Patent Application No. 2010-228656, filed Oct. 8, 2010, and Japanese Patent Application No. 2011-166434, filed Jul. 29, 2011, the entire contents of each of which are hereby incorporated by reference.

### BACKGROUND

1. Technical Field

This disclosure relates to a mirror, a mirror device, a laser apparatus, and an extreme ultraviolet (EUV) light generation apparatus.

2. Related Art

Photolithography processes have been continuously improving for semiconductor device fabrication. Extreme ultraviolet (EUV) light at a wavelength of approximately 13 nm is useful in the photolithography processes to form extremely small features (e.g., 32 nm or less features) in, for example, semiconductor wafers.

Three type of systems for generating EUV light have been well known. The systems includes an LPP (Laser Produced Plasma) type system in which plasma generated by irradiating a target material with a laser beam is used, a DPP (Discharge Produced Plasma) type system in which plasma generated by electric discharge is used, and an SR (Synchrotron Radiation) type system in which orbital radiation is used.

### SUMMARY

Embodiments detailed herein describe a mirror includes a mirror base provided with a flow channel through which a heat medium passes for cooling the mirror. The flow channel may include a buffer tank portion for adjusting a flow rate of the heat medium in the flow channel. A reflective film may be provided on the mirror base.

In another aspect, a mirror device includes the mirror. The mirror device may also include a pipe connected to the flow channel provided in the mirror. A pressure-feed device and a cooling device may be provided on the pipe.

In yet another aspect, a laser apparatus includes a master oscillator, and an amplifier including the mirror.

In yet another aspect, an extreme ultraviolet light generation apparatus includes a chamber in which extreme ultraviolet light is generated. a target supply unit is provided to the chamber for supplying a target material to a region inside the chamber to generate the extreme ultraviolet light. The extreme ultraviolet light generation apparatus also includes the mirror.

### BRIEF DESCRIPTION OF THE DRAWINGS

FIG. 1 schematically illustrates the configuration of an EUV light generation system according to a first embodiment of this disclosure.

FIG. 2 schematically illustrates an example of a flow channel provided in a mirror base of a mirror according to the first embodiment.

FIG. 3 is a side view schematically illustrating an example of a flat mirror according to the first embodiment.

FIG. 4 is a sectional view schematically illustrating the configuration of the flat mirror illustrated in FIG. 3, along a plane orthogonal to a reflective surface thereof.

FIG. 5 is a sectional view schematically illustrating the configuration of the flat mirror illustrated in FIG. 4, along V-V plane.

FIG. 6 is a sectional view schematically illustrating the configuration of the flat mirror illustrated in FIG. 4, along VI-VI plane.

FIG. 7 schematically illustrates an example of a mirror device and pressure applied to a heat medium at each location in the mirror device according to the first embodiment.

FIG. 8 is a side view schematically illustrating the configuration of a flat mirror according to a second embodiment of this disclosure.

FIG. 9 is a sectional view schematically illustrating the configuration of the flat mirror illustrated in FIG. 8, along a plane orthogonal to a reflective surface thereof.

FIG. 10 is a partial perspective view schematically illustrating a mirror base of the flat mirror illustrating in FIG. 8.

FIG. 11 is a sectional view schematically illustrating the configuration of the flat mirror illustrated in FIG. 9, along XI-XI plane.

FIG. 12 is a sectional view schematically illustrating the configuration of the flat mirror illustrated in FIG. 9, along XII-XII plane.

FIG. 13 is a sectional view schematically illustrating the configuration of the flat mirror illustrated in FIG. 9, along XIII-XIII plane.

FIG. 14 is a sectional view schematically illustrating the configuration of the flat mirror illustrated in FIG. 9, along XIV-XIV plane.

FIG. 15 is a side view schematically illustrating an example of a flat mirror according to a third embodiment of this disclosure.

FIG. 16 is a sectional view schematically illustrating the configuration of the flat mirror illustrated in FIG. 15, along a plane orthogonal to a reflective surface thereof.

FIG. 17 is an exploded perspective view schematically illustrating a mirror base of the flat mirror illustrated in FIG. 15.

FIG. 18 is a plan view schematically illustrating flow channels radially disposed in the flat mirror illustrated in FIG. 15.

FIG. 19 is a sectional view schematically illustrating the configuration of the flat mirror illustrated in FIG. 16, along XIX-XIX plane.

FIG. 20 is a sectional view schematically illustrating one of the flow channels radially disposed in the flat mirror illustrated in FIG. 15.

FIG. 21 is another sectional view schematically illustrating one of the flow channels radially disposed in the flat mirror illustrated in FIG. 15.

FIG. 22 is a partial perspective sectional view schematically illustrating a mirror base of the flat mirror illustrated in FIG. 15.

FIG. 23 is a plan view schematically illustrating an example of a concave mirror according to a fourth embodiment of this disclosure.

FIG. 24 is a longitudinal sectional view schematically illustrating the configuration of the concave mirror illustrated in FIG. 23.

FIG. 25 schematically illustrates an example of a mirror device and pressure applied to a heat medium at each location in the mirror device according to a fifth embodiment of this disclosure.

FIG. 26 schematically illustrates an example of an amplifier in a laser apparatus according to a sixth embodiment of this disclosure.

FIG. 27 schematically illustrates an example of an EUV light generation system according to a seventh embodiment of this disclosure.

FIG. 28 schematically illustrates a wavefront correction device in one state of operation, which can be a constituent element of the laser apparatus or the EUV light generation system according to the embodiments of this disclosure.

FIG. 29 schematically illustrates the wavefront correction device in another state of operation.

FIG. 30 schematically illustrates the wavefront correction device in yet another state of operation.

FIG. 31 schematically illustrates another wavefront correction device in one state of operation, which can be a constituent element of the laser apparatus or the EUV light generation system according to the embodiments of this disclosure.

FIG. 32 schematically illustrates the wavefront correction device in another state of operation.

FIG. 33 schematically illustrates the wavefront correction device in yet another state of operation.

FIG. 34 schematically illustrates yet another wavefront correction device, which can be a constituent element of the laser apparatus or the EUV light generation system according to the embodiments of this disclosure.

FIG. 35 schematically illustrates still another wavefront correction device, which can be a constituent element of the laser apparatus or the EUV light generation system according to the embodiments of this disclosure.

FIG. 36 schematically illustrates the configuration of a wavefront measurement unit in a wavefront correction device, which can be a constituent element of the laser apparatus or the EUV light generation system according to the embodiments of this disclosure.

FIG. 37 schematically illustrates the configuration of another wavefront measurement unit in the wavefront correction device.

FIG. 38 schematically illustrates the configuration of yet another wavefront measurement unit in the wavefront correction device.

FIG. 39 schematically illustrates the configuration of still another wavefront measurement unit in the wavefront correction device.

### DESCRIPTION

Hereinafter, selected embodiments for implementing this disclosure will be described in detail with reference to the accompanying drawings. In the description to follow and the accompanying drawings, each drawing merely illustrates shape, size, positional relationship, and so on, schematically to the extent that enables the content of this disclosure to be understood; thus, this disclosure is not limited to the shape, the size, the positional relationship, and so on, illustrated in each drawing. In order to show the configuration clearly, part of hatching along a section may be omitted in the drawings. Further, numerical values indicated herein are merely preferred examples of this disclosure; thus, this disclosure is not limited to the indicated numerical values.

### First Embodiment

A mirror, a mirror device, and an EUV light generation system to which the mirror device is applied according to a first embodiment will be described in detail with reference to the accompanying drawings. In the description to follow, an LPP-type EUV light generation system will be illustrated as an example. Without being limited thereto, however, this disclosure may be applied to a DPP-type system or to an SR-type system. Further, in the first embodiment, a system in which a target material is turned into plasma with single-stage laser irradiation will be illustrated. However, without being limited thereto, this disclosure may be applied to a system in which a target material is turned into plasma with multiple-stage laser irradiation.

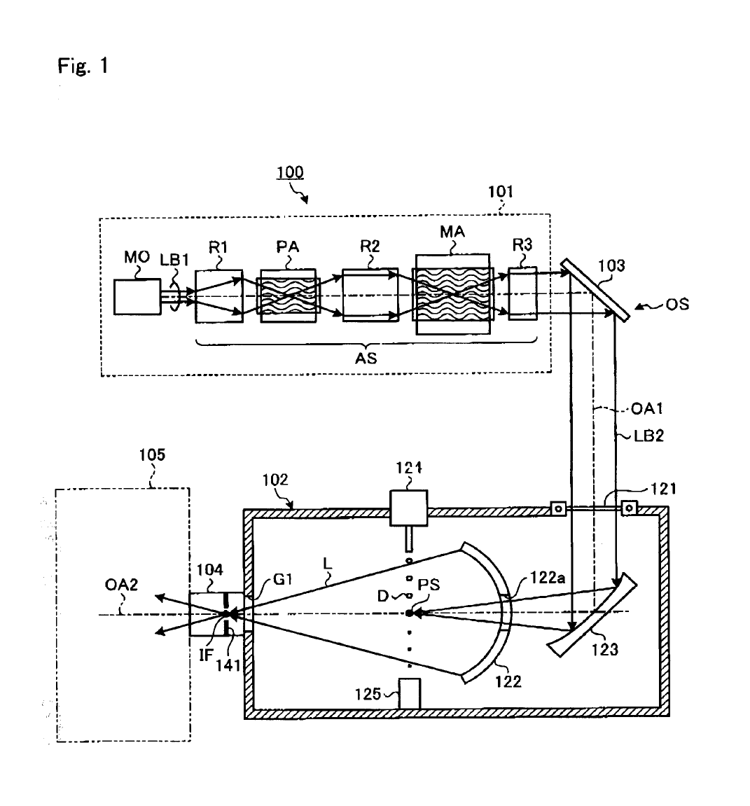

FIG. 1 schematically illustrates an EUV light generation system according to the first embodiment. As illustrated in FIG. 1, an EUV light generation system 100 include, for example, a driver laser apparatus 101, a chamber 102, and a beam steering optical system OS. The driver laser apparatus 101 may be configured to output a laser beam LB2. The beam steering optical system OS is configured to guide the laser beam LB2 from the driver laser apparatus 101 to the chamber 102 in which a target material is irradiated with the beam. Accordingly, the target material is turned into plasma from which EUV light is emitted.

The driver laser apparatus 101 may include a master oscillator MO, and an amplification optical system AS. The master oscillator MO is configured to output a laser beam LB1. The amplification optical system AS is configured to amplify the laser beam LB1 from the master oscillator MO. The amplification optical system AS may include a relay optical system R1, a preamplifier PA, a relay optical system R2, a main amplifier MA, and a relay optical system R3. The relay optical system R1 may be configured to expand a beam diameter of the laser beam LB1 from the master oscillator MO. The preamplifier PA is configured to amplify the laser beam LB1 of which the beam diameter has been expanded. The relay optical system R2 may be configured to collimate the amplified laser beam LB1. The main amplifier MA is configured to further amplify the collimated laser beam LB1. The relay optical system R3 may be configured to collimate the amplified laser beam LB1 and to output the collimated laser beam LB1. The laser beam from the driver laser apparatus 101 is referred to as a laser beam LB2.

The beam steering optical system OS may include at least one flat mirror 103. The flat mirror 103 is disposed to receive the laser beam LB2 from the driver laser apparatus 101 and to reflect the laser beam LB2 toward a window 121 in the chamber 102. A dashed-dotted line OA1 in FIG. 1 indicates a beam axis of the laser beam from the driver laser 101 and reflected by the flat mirror 103.

The chamber 102 may include the window 121, an off-axis paraboloidal mirror 123, a target supply unit 124, a target collection unit 125, and an EUV collector mirror 122. The window 121 serves as an inlet through which the laser beam LB2 is introduced into the chamber 102. The off-axis paraboloidal mirror 123 may be disposed to receive the laser beam LB2 introduced into the chamber 102 and to reflect the beam to focus it on a plasma generation region PS. The target supply unit 124 is configured to supply the target material to the plasma generation region PS in the form of droplets D. The target material that has passed the plasma generation region PS may be collected into a target collection unit 125. When the target material is irradiated with the laser beam LB2 at the plasma generation region PS, the material is turned into plasma from which EUV light L is emitted. The EUV collector mirror 122 may be configured to selectively reflect the EUV light L at a desired wavelength. The central wavelength of the EUV light L is, for example, approximately 13.5 nm. The EUV light L that has been selectively reflected by the EUV collector mirror 122 may be focused on an intermediate focus IF inside an exposure apparatus connection 104. The EUV collector mirror 122 may be provided with a through-hole 122a, through which the laser beam LB2 travels from the paraboloidal mirror 123 toward the plasma generation region PS. A dashed-dotted line OA2 in FIG. 1 indicates a beam axis of a laser beam reflected by the off-axis paraboloidal mirror 123 and an axis of the EUV light L reflected by the EUV collector mirror 122.

The target material may be supplied in the form of, but not limited to, a solid target, such as a ribbon and a disc, to the plasma generation region PS. Further, the off-axis paraboloidal mirror 123 may be disposed outside the chamber 102. In that case, the laser beam LB2 reflected by the flat mirror 103 may be reflected by the off-axis paraboloidal mirror 123 so as to travel through the window 121 and the through-hole 122a toward the plasma generation region PS on which the beam is focused.

The chamber 102 and the exposure apparatus connection 104 may be connected airtightly to each other with a gate valve G1. The EUV light L focused on the intermediate focus IF may be guided to an exposure apparatus 105 through an aperture 141 positioned at or around the intermediate focus IF. The EUV light L guided to the exposure apparatus 105 can be used in semiconductor lithography, for example. Alternatively, the EUV light L may be guided to a processing apparatus, instead of the exposure apparatus 105.

A mirror on which a high-output laser beam, such as the laser beam LB2, is incident is heated by the laser beam incident thereon. This may cause optical properties of the mirror to be changed. Such a change in the optical properties due to a heat load may lead to deterioration in the focusing performance of the mirror. Further, a mirror on which relatively high-output light, such as the EUV light L, is incident may also be heated by the light incident thereon. The focusing performance of the mirror may also be deteriorated.

Accordingly, a cooling mechanism may be provided to mirror bases of, for example, the flat mirror 103, the EUV collector mirror 122, and the off-axis paraboloidal mirror 123, respectively. For example, when mirrors are disposed in the relay optical systems R1 through R3, and the main amplifier MA, respectively, cooling mechanisms may also be provided to respective mirror bases of those mirrors. Here, an example of the mirror according to the first embodiment will be described in detail with reference to the drawings. This disclosure, however, is not limited thereto, and various modifications may be made to the cooling mechanism in the mirror base.

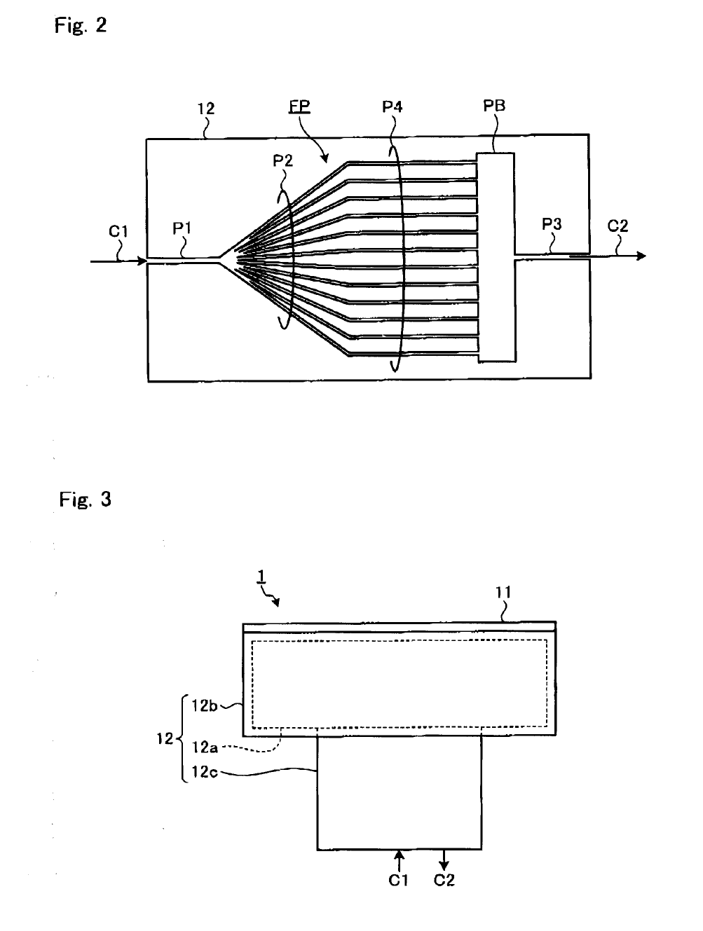

FIG. 2 schematically illustrates an example of a flow channel provided in a mirror base of a mirror according to the first embodiment. As shown in FIG. 2, a flow channel FP through which a heat medium C1 flows may be provided in a mirror base 12. The mirror base 12 and a reflective film formed on the base may be cooled with the heat medium C1. The heat medium C1 may be water, oil, liquid, and metal. The flow channel FP may include a first flow channel, a second flow channel, a buffer tank portion, a third flow channel, and a fourth flow channel. The first flow channel may be an inlet channel P1 through which the heat medium C1 supplied from a heat medium supply source may flow into the mirror base 12. The second flow channel may include a plurality of flow channels P2 which branches off radially from the inlet channel P1. The fourth flow channel may be return channels P4 which may allow communication between a buffer tank portion PB and the flow channels P2. The buffer tank portion PB may be in communication with the flow channels P2 either directly or indirectly. The third flow channel may be an outlet channel P3 through which the heat medium having flowed into the buffer tank portion PB (hereinafter, referred to as heat medium C2) may flow out of the mirror base 12.

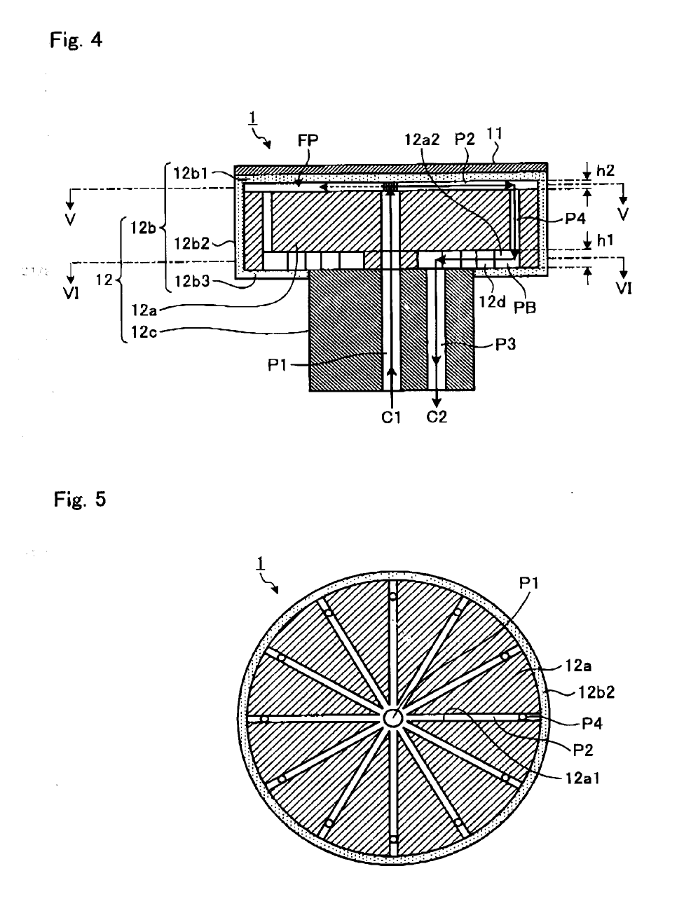

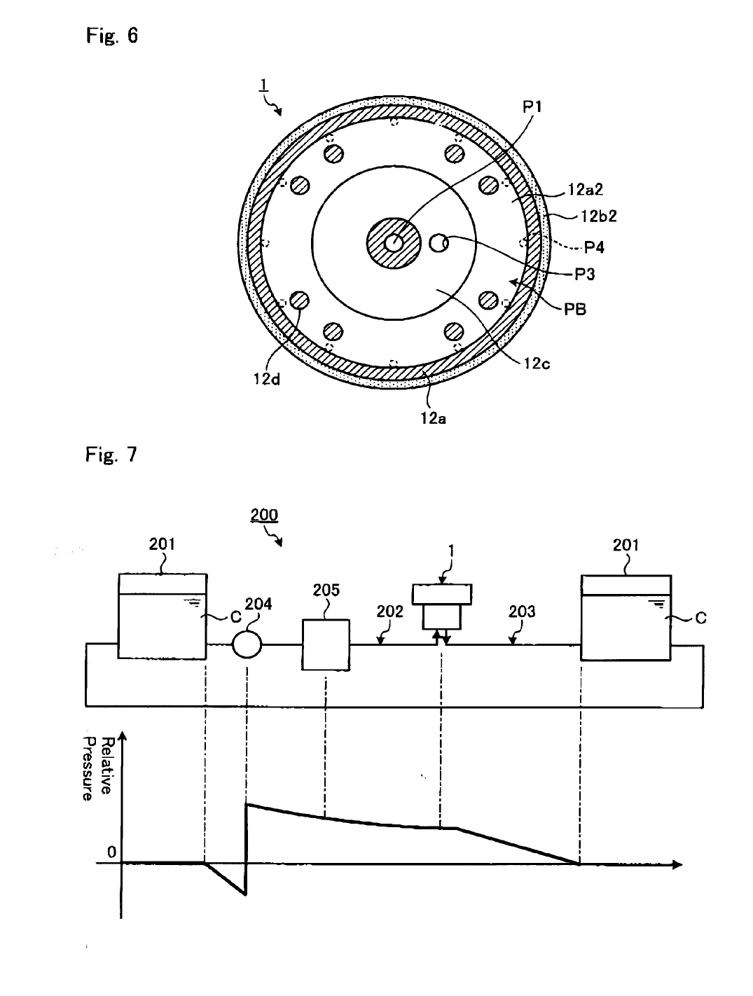

An example of a mirror provided with the mirror base 12 will be described in detail with reference to the drawings. In the description to follow, a flat mirror will be illustrated as an example. This disclosure, however, is not limited thereto, and this disclosure may be applied to various mirrors, such as a paraboloidal mirror including an off-axis paraboloidal mirror, a concave mirror, a convex mirror, and so forth. FIG. 3 is a side view schematically illustrating an example of the flat mirror according to the first embodiment. FIG. 4 is a sectional view schematically illustrating the configuration of the flat mirror illustrated in FIG. 3, along a plane orthogonal to the reflective surface thereof. FIG. 5 is a sectional view schematically illustrating the configuration of the flat mirror illustrated in FIG. 4, along V-V plane. FIG. 6 is a sectional view schematically illustrating the configuration of the flat mirror illustrated in FIG. 4, along VI-VI plane.

As shown in FIG. 3, a flat mirror 1 may include the mirror base 12 and a reflective film 11. The reflective film 11 may be formed on an upper surface of the mirror base 12. The reflective film 11 may be a dielectric multilayer reflective film. The mirror base 12 may include a base head 12a and a support 12c. The support 12c may be smaller in diameter than the base head 12a. The support 12c may be provided on a rear surface of the base head 12a. The base head 12a and the support 12c may preferably be made of a material having high thermal conductivity and high thermal resistance. In particular, the base head 12a may preferably be made of a material having high thermal conductivity.

As shown in FIGS. 3 and 4, the base head 12a may be a columnar member, for example. The base head 12a may be made of sintered silicon carbide, for example. The base head 12a may be covered by a head cover 12b of silicon carbide, for example. The head cover 12b may include a upper surface portion 12b1, a side surface portion 12b2, and a lower surface side 12b3. The upper surface portion 12b1 may cover the upper surface of the base head 12a. The side surface portion 12b2 may cover the side surface of the base head 12a. The lower surface portion 12b3 may cover the rear surface of the base head 12, except for the area in which the support 12c is connected to the base head 12a. The head cover 12b may be formed on the surface of the base head 12a with the CVC (Chemical Vapor Composite) method, for example. The support 12c may be made of sintered silicon carbide, for example, and connected to the rear surface side of the base head 12a through an adhesive.

As shown in FIGS. 4, 5, and 6, the flow channel FP provided in the mirror base 12 may include the inlet channel P1, the flow channels P2, the return channels P4, the buffer tank portion PB, and the outlet channel P3. The inlet channel P1 may serve as a path along which the heat medium C1 supplied from the heat medium supply source may flow into the mirror base 12. The flow channels P2 may branch off radially from the inlet channel P1. Thus, the heat medium C1 may flow substantially uniformly along the upper surface side of the mirror base 12. The return channels P4 may respectively be connected to the flow channels P2. The buffer tank portion PB may be connected to the return channels P4. The outlet channel P3 may serve as a path along which the heat medium C2 having flowed into the buffer tank portion PB may flow out of the mirror base 12.

The inlet channel P1 may open, at one end thereof, in a surface of the mirror base 12. The inlet channel P1 may be connected, at the other end thereof, to the flow channels P2 at one location along the upper surface side of the mirror base 12. As shown in FIG. 4, the inlet channel P1 may pass through the support 12c and the base head 12a from the lower surface of the support 12c to the upper surface of the base head 12a in substantially the center thereof. In this case, the inlet for the heat medium C1 may be the opening of the inlet channel P1 provided in the lower surface of the support 12c.

As shown in FIGS. 4 and 5, the flow channel P2 may be rectangular in shape when viewed from above. The flow channels P2 may branch off radially from the inlet channel P1 at substantially the center of the base head 12a and run along the upper surface toward the periphery of the base head 12a. Interior angles between two adjacent flow channels P2 may be substantially the same. In the case where the reflective surface of the flat mirror 1 is circular in shape, for example, the flat mirror 1 may preferably be configured such that the center of the reflective surface lies on the extension of the central line of the inlet channel P1. This configuration may make it possible to cause the heat medium C1 to flow point-symmetrically with respect to the center of the reflective surface.

Such flow channels P2 may be realized with a space defined by covering grooves 12a1 formed in the base head 12a with the upper surface portion 12b1 of the head cover 12b. Such flow channels P2 may be formed with a manufacturing technique using a sacrificial layer, for example. More specifically, the grooves 12a1 may be filled with a material that can be removed by ashing or the like as the sacrificial layer. The sacrificial layer may be removed by ashing or the like after the head cover 12b is formed with the CVC method. As a result, the space from which the sacrificial layer is removed may serve as the flow channels P2.

As shown in FIGS. 4 and 5, the flow channels P2 may be connected to the return channels P4, respectively, at the periphery side of the base head 12a. The return channels P4 may extend, inside the base head 12a, in a direction substantially perpendicular to the upper surface of the base head 12a. The return channels P4 may be connected to the buffer tank portion PB provided at the lower surface side of the base head 12a.

The buffer tank portion PB to which the return channels P4 are connected may be provided so as to make the flow rate of the heat medium C1 in the flow channels P2 and the return channels P4, respectively, substantially uniform. Providing the buffer tank portion PB may allow pressure drops caused when the heat medium C1 flows in the flow channels P2 and the return channels P4 to be made substantially uniform. With this, the flow rate of the heat medium C1 flowing in the flow channels may be made substantially uniform. Further, the buffer tank portion PB may be provided so as to absorb pressure fluctuation of the heat medium C1 flowing in the flow channels P2 and the return channels P4. A height h1 of the buffer tank portion PB may be higher than a height h2 of the flow channel P2. The cross-sectional area of the buffer tank portion PB may be larger than the cross-sectional area of the flow channels P2.

As shown in FIGS. 4 and 6, the buffer tank portion PB may be realized with a space defined by covering an annular groove 12a2 formed in the lower surface of the base head 12a with the lower surface portion 12b3 of the head cover 12b. In this case, the buffer tank portion PB may be formed similarly to the flow channels P2. That is, the groove 12a2 may be filled with a material that can be removed by ashing or the like as the sacrificial layer. The sacrificial layer may be removed by ashing or the like after the head cover 12b is formed with the CVC method. As a result, the space from which the sacrificial layer is removed may serve as the buffer tank portion PB. The buffer tank portion PB may be provided with at least one pillar 12d thereinside for supporting the lower surface portion 12b3 of the head cover 12b.

The outlet channel P3 may be connected, at one end thereof, to the buffer tank portion PB and may open, at the other end thereof, in the surface of the mirror base 12. As shown in FIGS. 4 and 6, the outlet channel P3 may pass through the support 12c in the thickness direction thereof, for example. In this case, an outlet for the heat medium C2 may be the opening in the outlet channel P3 provided in the lower surface of the support 12c.

In the flat mirror 1 provided with the above-described flow channel FP, the mirror base 12 and the reflective film 11 may be cooled by making the heat medium C1 flow in the flow channel FP. With this, a rise in the temperature in and around the reflective surface of the mirror may be suppressed, and thermal deformation in the reflective surface may be reduced. When, for example, the flat mirror 1 is used as the flat mirror 103 shown in FIG. 1, the thermal deformation in the reflective surface thereof can be reduced. Therefore, the laser beam LB2 having a desired beam profile may be focused in the plasma generation region PS with high accuracy and with high precision.

In the flat mirror 1, the flow channel FP may include the buffer tank portion PB. With this, it is contemplated that a sudden fluctuation in pressure inside the flow channel FP caused when the heat medium C1 starts or stops to be supplied into the flow channel FP may be reduced. Further, even in a case where pulsating heat medium C1 is supplied to the inlet channel P1 due to pressure fluctuation, the fluctuation in the pressure of the heat medium C1 inside the flow channel FP may be reduced. As a result, even when the head cover 12b is made as thin as approximately 1 mm in thickness, damage to the head cover 12b may be suppressed.

The flat mirror 1 may preferably be disposed such that the center of the radially-disposed flow channels P2 substantially coincides with the beam axis of the laser beam to be reflected thereby. Typically, the peak in intensity in a beam profile of a laser beam lies on the beam axis thereof. Accordingly, the flat mirror 1 may be configured such that the center of the radially-disposed flow channels P2, at which the highest cooling performance may be exhibited, coincides with the center of the reflective surface, and the flat mirror 1 may be disposed such that the beam axis of the laser beam incident thereon coincides with the center of the reflective surface. With this, an uneven rise in the temperature in the reflective surface may be suppressed.

The flat mirror 1 may be combined with a given pipe, a pressure-feed device, a cooling device for cooling the heat medium, and so forth, to constitute a mirror device. Hereinafter, an example of the mirror device will be described with reference to FIG. 7.

FIG. 7 schematically illustrates an example of the mirror device and pressure applied to the heat medium at each location in the mirror device according to the first embodiment. As shown in FIG. 7, a mirror device 200 may include a heat medium supply source 201, a supply pipe 202, and a discharge pipe 203, for example. A heat medium C for cooling the above-described flat mirror 1 may be stored in the heat medium supply source 201. The supply pipe 202 may allow communication between the heat medium supply source 201 and the inlet channel P1 of the flat mirror 1. The discharge pipe 203 may allow communication between the outlet channel P3 of the flat mirror 1 and the heat medium supply source 201. The supply pipe 202 may be provided with a pressure-feed device 204, a cooling device 205, and so forth. The pressure-feed device 204 may be configured to pressure-feed the heat medium C inside the heat medium supply source 201 toward the inlet channel P1. The cooling device 205 may be configured to cool the heat medium C flowing in the supply pipe 202. The cooling device 205 may be provided downstream of the pressure-feed device 204. In FIG. 7, the heat medium supply source 201 is illustrated in duplicate in order to show the relative pressure fluctuation inside the mirror device 200.

A tank of a predetermined volume may be used as the heat medium supply source 201 for storing the heat medium C, for example. A pipe made of an inorganic material such as a metal, or a pipe made of an organic material such as a synthetic resin may be used for the supply pipe 202 and the discharge pipe 203. An electrical pump or the like may be used for the pressure-feed device 204. A heat exchanger, such as a heat pump, may be used for the cooling device 205.

When the pressure-feed device 204 is actuated, the heat medium C inside the heat medium supply source 201 flows into the flow channel FP in the flat mirror 1 via the supply pipe 202, and then passes through the flow channel FP to flow into the discharge pipe 203. Thereafter, the heat medium C passes through the discharge pipe 203 and returns to the heat medium supply source 201. The heat medium C may be used repeatedly.

As shown in FIG. 7, when the relative pressure inside the heat medium supply source 201 with respect to the atmospheric pressure is assumed to be 0, the relative pressure inside the mirror device 200 may decrease toward the pressure-feed device 204. The relative pressure may be at the lowest in the pressure-feed device 204. Once the heat medium C reaches the pressure-feed device 204, the pressure thereof may be raised in the pressure-feed device 204. After the pressure of the heat medium C is raised in the pressure-feed device 204, the relative pressure inside the mirror device 200 may be at the highest. The relative pressure may gradually decrease from the pressure-feed device 204 toward the cooling device 205, the flow channel FP in the flat mirror 1, and the heat medium supply source 201. The relative pressure may become 0 when the heat medium C returns to the heat medium supply source 201.

When both the pressure-feed device 204 and the cooling device 205 are actuated, the heat medium C having been cooled in the cooling device 205 may be supplied into the flow channel FP in the flat mirror 1 via the supply pipe 202. With this, compared to the case where only the pressure-feed device 204 is actuated, the flat mirror 1 may be cooled more efficiently.

### Second Embodiment

When a flow channel including a buffer tank portion is provided in a mirror base including a base head, a head cover, and a support, the buffer tank portion may be disposed inside the base head, inside the support, or between the base head and the support.

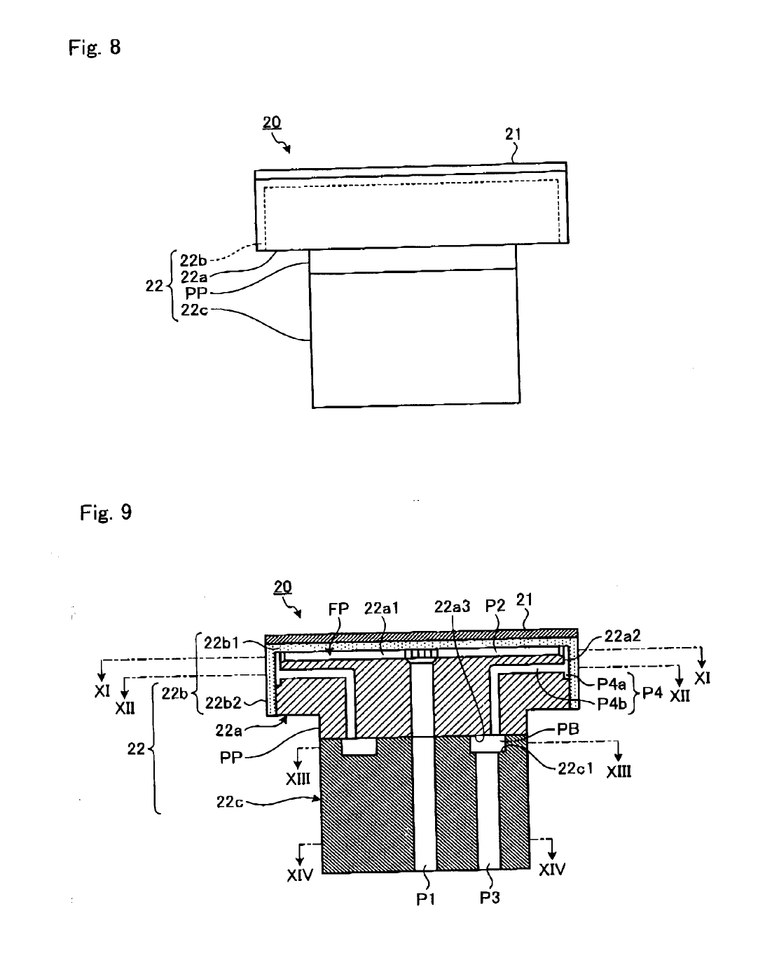

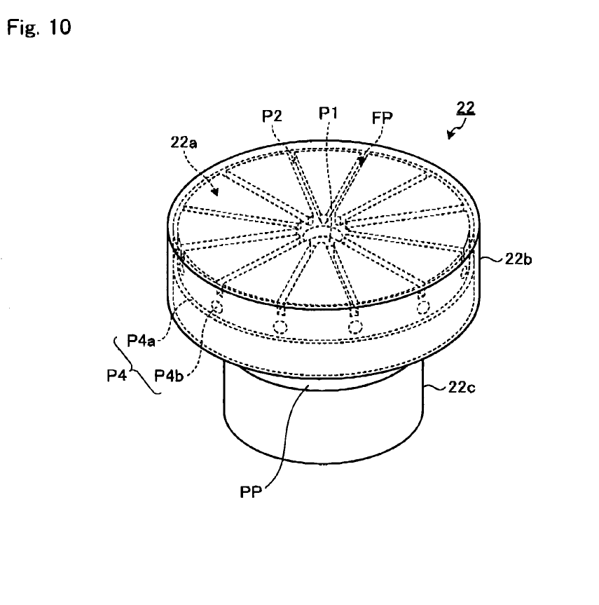

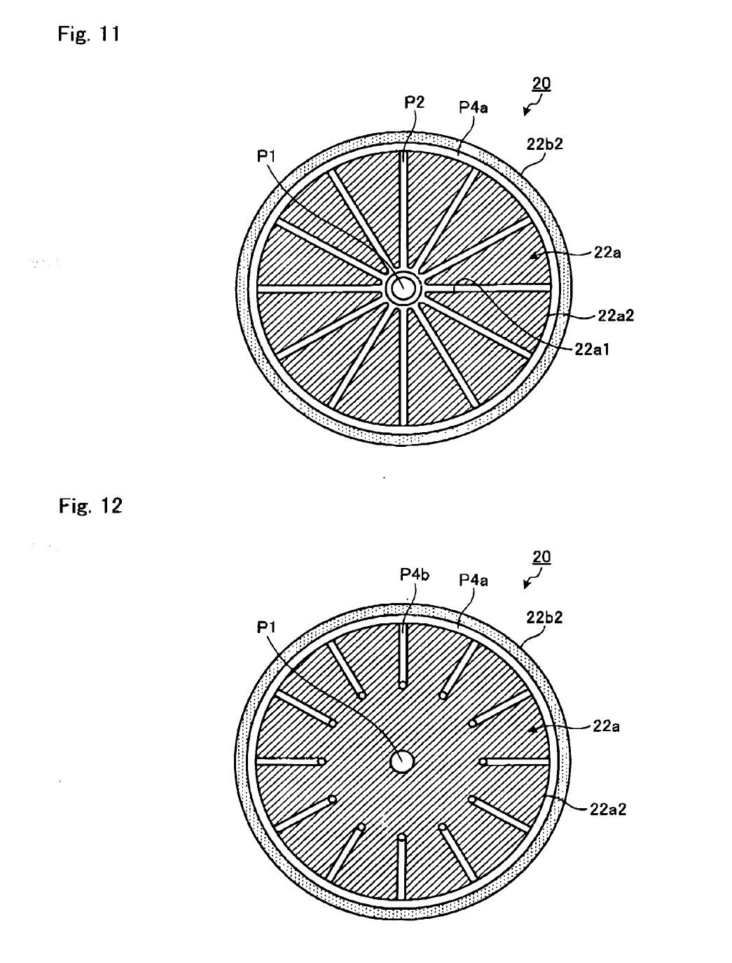

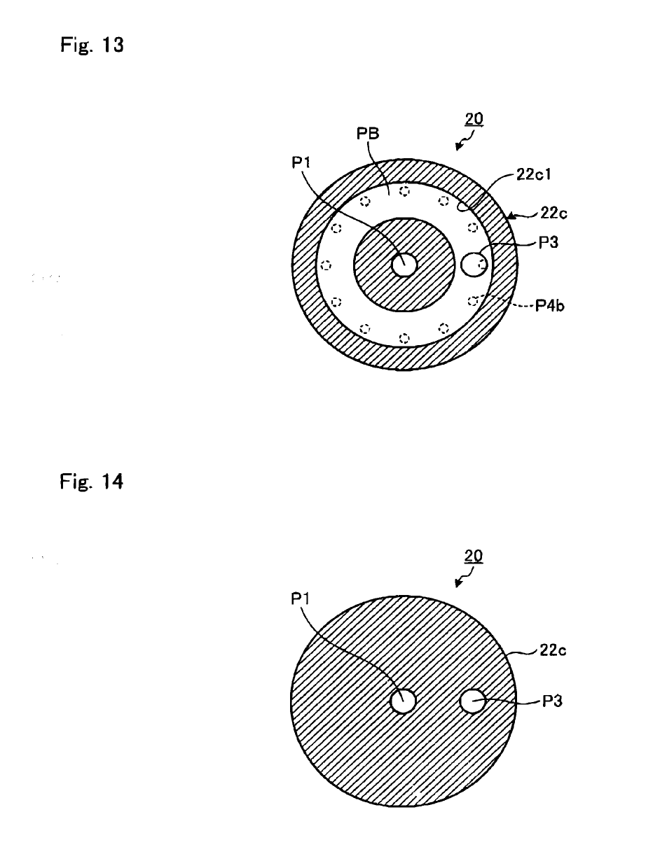

FIG. 8 is a side view schematically illustrating an example of a flat mirror according to a second embodiment of this disclosure. FIG. 9 is a sectional view schematically illustrating the configuration of the flat mirror illustrated in FIG. 8, along a plane orthogonal to the reflective surface thereof. FIG. 10 is a partial perspective view schematically illustrating a mirror base of the flat mirror illustrated in FIG. 8. FIG. 11 is a sectional view schematically illustrating the configuration of the flat mirror illustrated in FIG. 9, along XI-XI plane. FIG. 12 is a sectional view schematically illustrating the configuration of the flat mirror illustrated in FIG. 9, along XII-XII plane. FIG. 13 is a sectional view schematically illustrating the configuration of the flat mirror illustrated in FIG. 9, along XIII-XIII plane. FIG. 14 is a sectional view schematically illustrating the configuration of the flat mirror illustrated in FIG. 9, along XIV-XIV plane.

As shown in FIG. 8, a flat mirror 20 may include a mirror base 22 and a reflective film 21. The reflective film 21 may be formed on the upper surface side of the mirror base 22 to constitute the reflective surface. The reflective film 21 may be a dielectric multilayer reflective film, for example. The mirror base 22 may include a base head 22a and a support 22c. The base head 22a may have the reflective film 21 formed on the upper surface side thereof. The base head 22a may include a disc-shaped projection PP on the lower surface side at the center thereof. The support 22c may be provided at the lower surface side of the projection PP. The base head 22a and the support 22c may preferably be made of a material having high thermal conductivity and high thermal resistance. In particular, the base head 22a may preferably be made of a material of high thermal conductivity.

The base head 22a may be made of sintered silicon carbide, for example. As shown in FIGS. 8 and 9, the base head 22a may be covered by a head cover 22b made of silicon carbide, for example. The head cover 22b may include an upper surface portion 22b1 and a side surface portion 22b2. The upper surface portion 22b1 may cover an upper surface of the base head 22a. The side surface portion 22b2 may cover the side surface of the base head 22a. Such head cover 22b may be formed on the base head 22a with the CVC method, for example. The support 22c may be made of sintered silicon carbide, for example. As shown in FIGS. 8 and 9, the support 22c may be attached to the lower surface side of the projection PP with an adhesive.

As shown in FIGS. 9 through 14, the flow channel FP provided in the mirror base 22 may include the inlet channel P1, the flow channels P2, the return channels P4, the buffer tank portion PB, and the outlet channel P3. The inlet channel P1 may serve as a path along which the heat medium supplied from the heat medium supply source may flow into the mirror base 22. The flow channels P2 may branch off radially from the inlet channel P1. With this, the heat medium may flow substantially uniformly along the upper surface side of the mirror base 22. The return channels P4 may be connected to the flow channels P2, respectively. The buffer tank portion PB may be connected to the return channels P4. The outlet channel P3 may serve as a path along which the heat medium having flowed into the buffer tank portion PB may flow out of the mirror base 22. The return channels P4 may include an annular flow channel portion P4a and connecting flow channel portions P4b. The annular flow channel portion P4a may be connected to the flow channels P2. The connecting flow channel portions P4b may allow communication between the annular flow channel portion P4a and the buffer tank portion PB.

The inlet channel P1 may open, at one end thereof, in a surface of the mirror base 22. The inlet channel P1 may be connected, at the other end thereof, to the flow channels P2 at one location along the upper surface side of the mirror base 22. As shown in FIG. 9, the inlet channel P1 may pass through the support 22c and the base head 22a from the lower surface of the support 22c to the upper surface of the base head 22a in substantially the center thereof. In this case, the inlet for the heat medium may be the opening in the inlet channel P1 provided in the lower surface of the support 22c. The flow channel P1 may be configured such that, at the end to the side of the reflective film 21, the diameter thereof increases toward the end.

As shown in FIGS. 9 through 11, the flow channels P2 may branch off radially from the inlet channel P1 at substantially the center of the base head 22a along the upper surface thereof toward the periphery of the base head 22a. The flow channels P2 may be configured such that interior angles between two adjacent flow channels P2 are substantially the same, for example. In a case where the reflective surface of the flat mirror 20 is circular in shape, for example, the flat mirror 20 may preferably be configured such that the center of the reflective surface lies on the extension of the central line of the inlet channel P1. This configuration may make it possible to cause the heat medium to flow point-symmetrically with respect to the center of the reflective surface. Such flow channels P2 may be realized with a space defined by covering grooves 22a1 formed in the base head 22a with the upper surface portion 22b1 of the head cover 22b.

As shown in FIGS. 9 through 11, the flow channels P2 may be connected to the annular flow channel portion P4a at the periphery side of the base head 22a. The annular flow channel portion P4a may be realized with a space defined by covering a small-diameter portion 22a2 formed in the side surface of the base head 22a with the side surface portion 22b2 of the head cover 22b. Such flow channels P2 and annular flow channel portion P4a may be formed with a manufacturing technique using a sacrificial layer, for example. More specifically, the above-mentioned grooves 22a1 and the small-diameter portion 22a2 may be filled with a material that can be removed by ashing or the like as a sacrificial layer. The sacrificial layer may be removed by ashing or the like after the head cover 22b is formed with the CVC method. As a result, the space from which the sacrificial layer is removed may serve as the flow channels P2 and the annular flow channel portion P4a.

As shown in FIGS. 9, 10, 12, and 13, the annular flow channel portion P4a may be in communication with the buffer tank portion PB via the connecting flow channel portions P4b. The connecting flow channel portion P4b may include a portion extending from a location at which the connecting flow channel portion P4b is connected to the annular flow channel portion P4a toward the inner side of the base head 22a in a direction substantially perpendicular to the annular flow channel portion P4a, and a portion extending therefrom downwardly in a direction away from the reflective surface. The portion extending downwardly may be connected to the buffer tank portion PB at the lower surface 22a3 of the base head 22a. The connecting flow channel portions P4b may be in communication with the flow channels P2, respectively.

The buffer tank portion PB, to which the return channels P4 are connected, may be provided so as to make the flow rate of the heat medium C1 in the flow channels P2 and the return channels P4 substantially uniform. Providing the buffer tank portion PB may allow pressure drops caused when the heat medium flows in the flow channels P2 and the return channels P4 to be made substantially uniform. Further, the buffer tank portion PB may be provided so as to absorb pressure fluctuation of the heat medium C1 flowing in the flow channels P2 and the return channels P4. The buffer tank portion PB may be larger in cross-sectional area than the entire flow channels P2. As shown in FIGS. 9 and 13, the buffer tank portion PB may be realized with a space defined by covering an annular groove 22c1 formed in the upper surface of the support 22c with the lower surface portion 22a3 of the base head 22a.

The outlet channel P3, of which the one end is connected to the buffer tank portion PB, may open, at the other end thereof, in the surface of the mirror base 22. As shown in FIGS. 9 and 14, the outlet channel P3 may pass through the support 22c in the thickness direction thereof, for example. In this case, the outlet for the heat medium may be the opening of the outlet channel P3 provided in the lower surface of the support 22c.

The flat mirror 20 provided with the above-described flow channel FP may be cooled by making the heat medium flow in the flow channel FP. With this, a rise in the temperature in the flat mirror 20 may be suppressed, and thermal deformation in the reflective surface may be reduced. When, for example, the flat mirror 20 is applied to the flat mirror 103 shown in FIG. 1, the thermal deformation in the reflective surface thereof is reduced. Accordingly, the laser beam LB2 having a desired beam profile may be focused in the plasma generation region PS with high accuracy and with high precision.

In the flat mirror 20, the buffer tank portion PB may be defined at the connection between the base head 22a and the support 22c. Accordingly, compared to the case where part of the head cover 22 is made to serve as part of a wall of the buffer tank portion PB, the mechanical strength of the buffer tank portion PB may be increased. With this, even if the flow rate of the heat medium supplied into the flow channel FP is increased, a sudden fluctuation in pressure inside the flow channel FP caused when the heat medium starts or stops to be supplied into the flow channel FP may be absorbed by the buffer tank portion PB. Further, disposing the flat mirror 20 such that the center of the radially-disposed flow channels P2 substantially coincides with the beam axis of the laser beam to be reflected thereby may make the temperature distribution in the reflective surface substantially point-symmetric with respect to the center thereof. In this case, the wavefront of the laser beam reflected by the flat mirror 20 may likely be corrected easily with adaptive optics.

As in the flat mirror 1 according to the first embodiment, the flat mirror 20 may be combined with a given pipe, a pressure-feed device, a cooling device for cooling the heat medium, and so forth, to constitute a mirror device. The mirror device including the flat mirror 20 may be configured similarly to the mirror device 200, except in that the flat mirror 1 in the mirror device 200 is replaced by the flat mirror 20.

### Third Embodiment

When a flow channel including a plurality of flow channels disposed radially is provided in a mirror base, the shape of the respective flow channels disposed radially may not necessarily be rectangular but may be sectoral, trapezoidal, and so forth, as viewed from above.

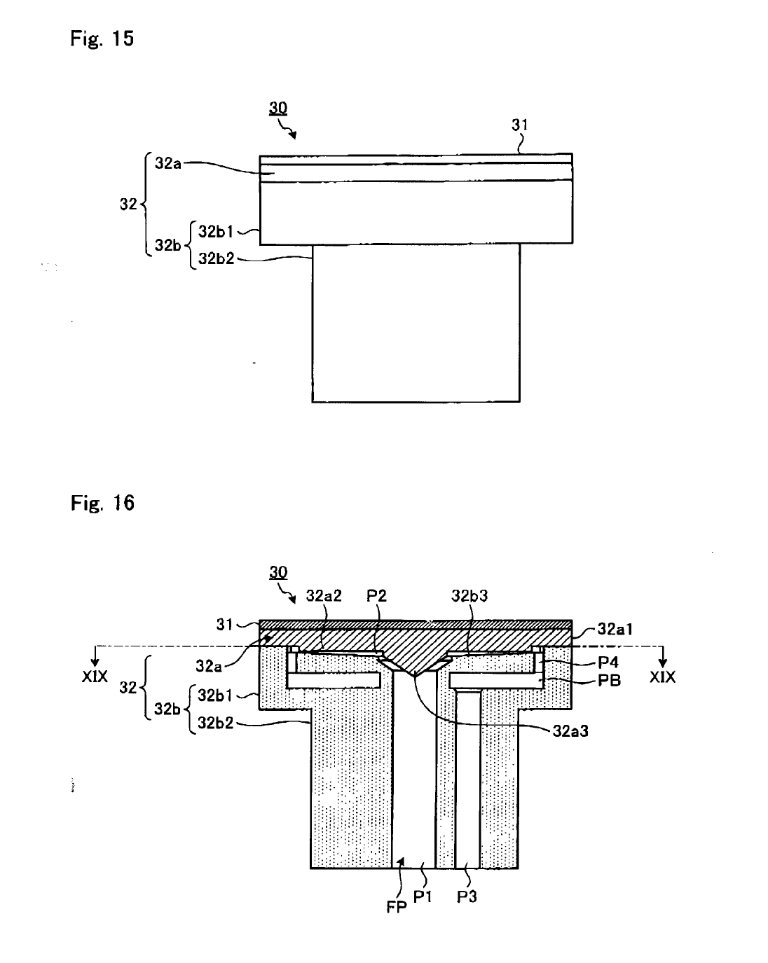

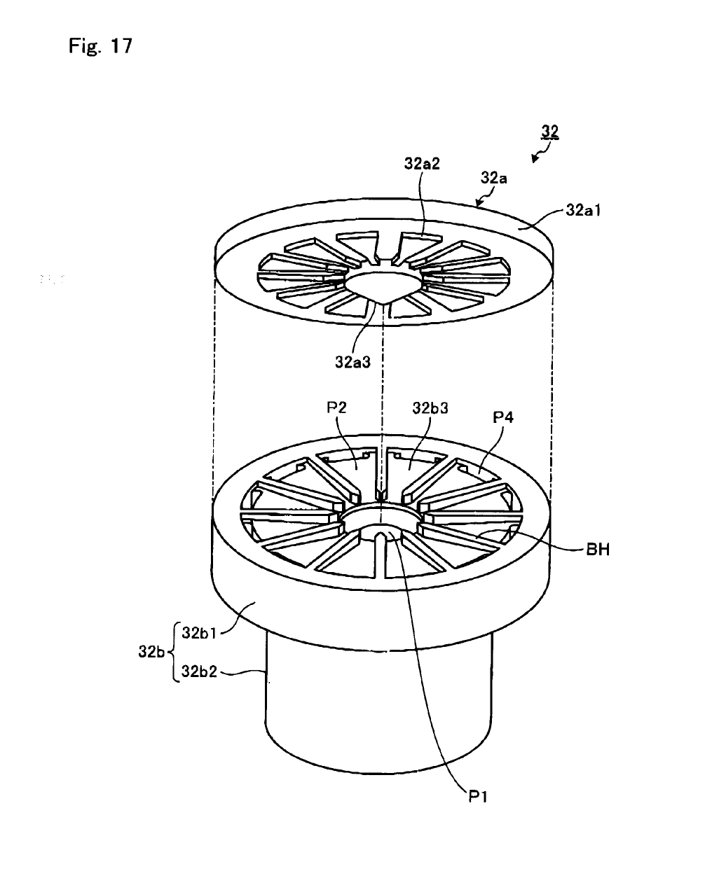

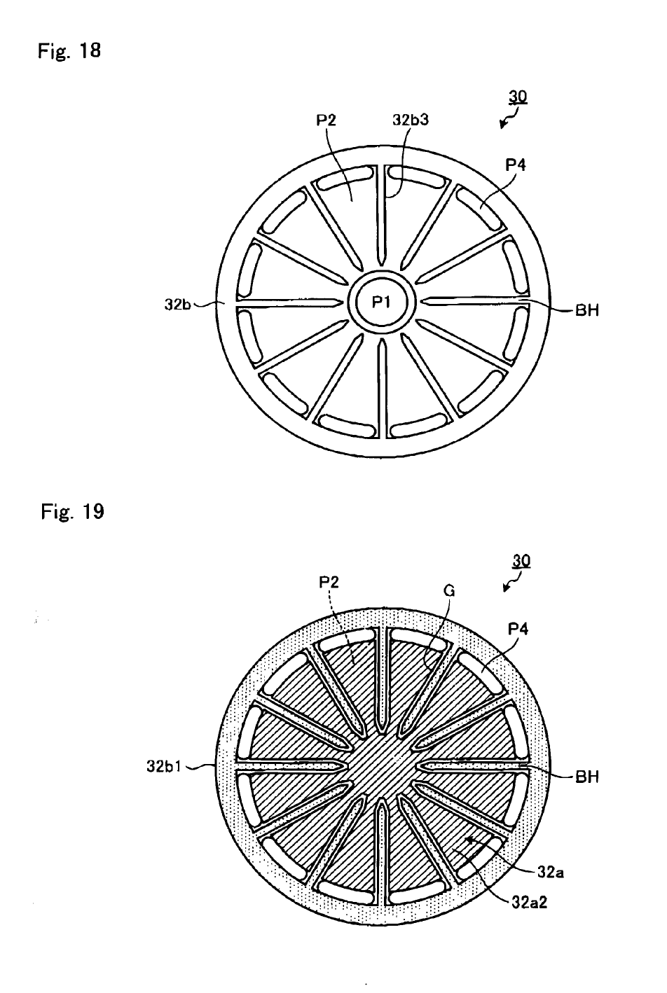

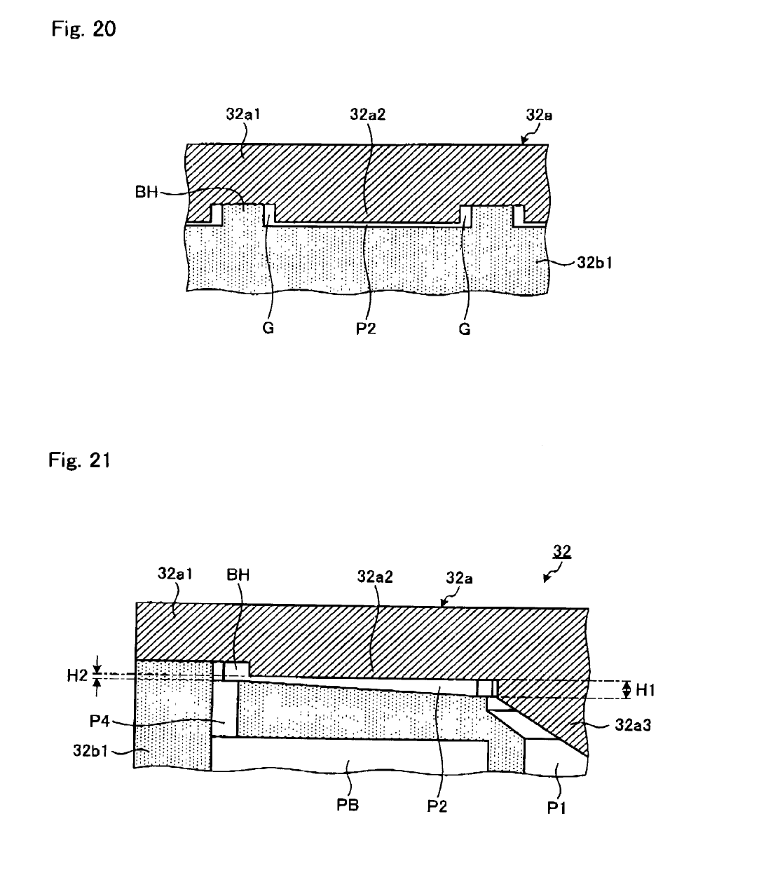

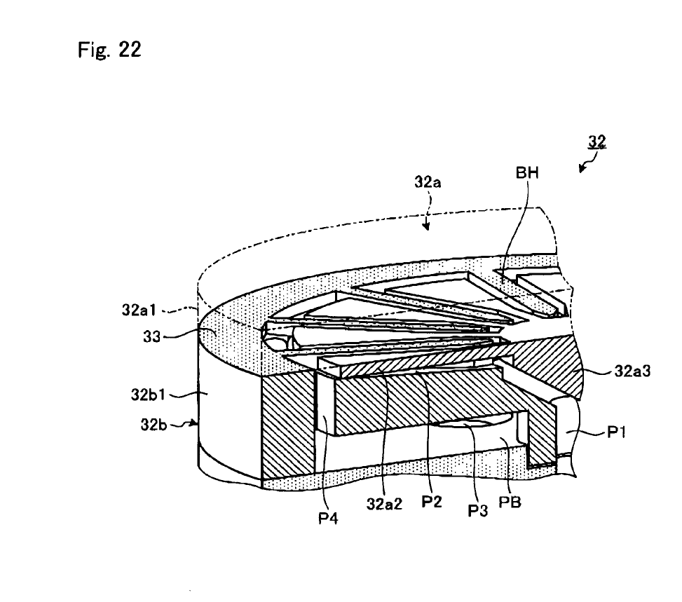

FIG. 15 is a side view schematically illustrating an example of a flat mirror according to a third embodiment of this disclosure. FIG. 16 is a sectional view schematically illustrating the configuration of the flat mirror illustrated in FIG. 15, along a plane orthogonal to the reflective surface thereof. FIG. 17 is an exploded perspective view schematically illustrating a mirror base of the flat mirror illustrated in FIG. 15. FIG. 18 is a plan view schematically illustrating flow channels radially disposed in the flat mirror illustrated in FIG. 15. FIG. 19 is a sectional view schematically illustrating the configuration of the flat mirror illustrated in FIG. 16, along XIX-XIX plane. FIG. 20 is a sectional view schematically illustrating one of the flow channels radially disposed in the flat mirror illustrated in FIG. 15. FIG. 21 is another sectional view schematically illustrating one of the flow channels radially disposed in the flat mirror illustrated in FIG. 15. FIG. 22 is a partial perspective sectional view schematically illustrating the mirror base of the flat mirror illustrated in FIG. 15.

As shown in FIG. 15, a flat mirror 30 may include a mirror base 32 and a reflective film 31, for example. The reflective film 31 may be formed on the upper surface side of the mirror base 32 to constitute the reflective surface. The reflective film 31 may be a dielectric multilayer reflective film, for example. The mirror base 32 may include a base head 32a and a support 32b. The base head 32a may be substantially planar in shape and may be provided with the reflective film 31 on the upper surface thereof. The support 32b may include a large-diameter portion 32b1 and a small-diameter portion 32b2. The support 32b may be shaped like the letter T as viewed from the side, in which the small-diameter portion 32b2 is connected to the lower surface of the large-diameter portion 32b1. The base head 32a may be provided on the upper surface of the large-diameter portion 32b1.

The base head 32a and the support 32b may preferably be made of a material having high thermal conductivity and high thermal resistance. In particular, the base head 32a may preferably be made of a material having high thermal conductivity. The base head 32a and the large-diameter portion 32b1 may be made of sintered silicon carbide, for example. The base head 32a may be bonded onto the upper surface of the large-diameter portion 32b1 with an inorganic adhesive, such as wax, solder, and inorganic glue, and an organic adhesive.

As shown in FIGS. 16 through 22, the flow channel FP inside the mirror base 32 may include the inlet channel P1, the flow channels P2, the return channels P4, the buffer tank portion PB, and the outlet channel P3. The inlet channel P1 may serve as a path along which the heat medium supplied from the heat medium supply source may flow into the mirror base 32. The flow channels P2 may branch off radially from the inlet channel P1. With this, the heat medium may flow substantially uniformly along the upper surface side of the mirror base 32. The return channels P4 may be connected to the flow channels P2, respectively. The buffer tank portion PB may be connected to the return channels P4. The outlet channel P3 may serve as a path along which the heat medium having flowed into the buffer tank portion PB may flow out of the mirror base 32.

The inlet channel P1 may open, at one end thereof, in a surface of the mirror base 32. The inlet channel P1 may be connected, at the other end thereof, to the radially-disposed flow channels P2 at one location of the upper surface side of the mirror base 32. As shown in FIG. 16, the inlet channel P1 may pass through the support 32b in the thickness direction thereof. In this case, the inlet for the heat medium may be the opening in the inlet channel P1 provided in the lower surface of the support 32b. The flow channel P1 may be configured such that, at the end toward the side of the base head 32a, the diameter thereof increases toward the end.

As shown in FIGS. 16 through 19, the flow channels P2 may branch off radially from the inlet channel P1 at substantially the center of the upper surface of the support 32b toward the periphery of the support 32b along the upper surface. The flow channels P2 may be configured such that interior angles between two adjacent flow channels P2 are substantially the same, for example. In the case where the reflective surface of the flat mirror 30 is circular in shape, for example, the flat mirror 30 may preferably be configured such that the center of the reflective surface lies on the extension of the central line of the inlet channel P1. This configuration may make it possible to allow the heat medium to flow point-symmetrically with respect to the center of the reflective surface. Such flow channels P2 may be realized with a space defined by covering grooves 32b3 formed in the upper surface side of the large-diameter portion 32b1 with base head 32a.

As shown in FIGS. 16 through 19 and in FIG. 21, the return channels 4 may connected to the flow channels P2, respectively, at the periphery side of the support 32b, for example. The return channels P4 may extend from the location at which the return channels P4 are connected to the flow channels P2, respectively, in a direction orthogonal to the flow channels 2, which is the thickness direction of the large-diameter portion 32b1.

The buffer tank portion PB, to which the return channels P4 are connected, may be provided so as to make the flow rate of the heat medium in the flow channels P2 and the return channels P4, respectively, substantially uniform. Providing the buffer tank portion PB may allow pressure drops caused when the heat medium flows in the flow channels P2 and the return channels P4 to be made substantially uniform. Further, the buffer tank portion PB may be provided so as to absorb pressure fluctuation of the heat medium flowing in the flow channels P2 and the return channels P4. The buffer tank portion PB may be larger in cross-sectional area than the entire flow channels P2. As shown in FIG. 16, the buffer tank portion PB may be realized with an annular space defined in the large-diameter portion 32b1.

The outlet channel P3 may be connected, at one end thereof, to the buffer tank portion PB, and may open, at the other end thereof, in the surface of the mirror base 32. As shown in FIG. 16, the outlet channel P3 may pass through the support 32b in the thickness direction thereof, for example. In this case, the outlet for the heat medium may be the opening in the outlet channel P3 provided in the lower surface of the support 32b.

In the third embodiment, as shown in FIGS. 17 and 18, the flow channel P2 may be sectoral in shape as viewed from above. The flow channel P2, as viewed from above, may be sectoral in shape in which the width gradually increases from the side of the inlet channel P1 toward the periphery of the support 32b. A partition BH for dividing the adjacent flow channels P2 may be formed into a rectangular parallelepiped. The partitions BH may be formed on the base head 32a or on the large-diameter portion 32b1. The return channels P4 may allow communication between the corresponding flow channels P2 and the buffer tank portion PB. The return channel P4 may, as viewed in cross-section, be an arc-shaped elongated hole which is curved about the inlet channel P1.

As shown in FIGS. 16 and 17, in the case where the flow channel P2 is formed into a sector, as viewed from above, the base head 32a may include a disc-shaped base 32a1, planar projections 32a2, and a conical flow regulating portion 32a3. The projections 32a2 may be provided on the lower surface side of the base 32a1 so as to correspond to respective grooves 32b3. The projections 32a2 may be inserted into the upper part of the respective grooves 32b3. The flow regulating portion 32a3 may be provided on the lower surface of the base 32a1 at substantially the center thereof with the apex thereof facing downward. The projections 32a2 may be sectoral in shape, as viewed from above, for example. Further, the projections 32a2 may be substantially uniform in thickness. The apex of the flow regulating portion 32a3 may project into the inlet channel P1.

As shown in FIGS. 19 and 20, a gap G may be defined between the projection 32a2 and the partition BH of the corresponding flow channel P2. The gap G may function as part of the flow channel P2. The return channels P4 may be provided such that the return channels P4 are positioned closer to the periphery of the support 32b than the projections 32a2. In FIG. 19, the topmost surface of the large-diameter portion 32b1 is smudged in order to allow the partition BH and the gap G to be differentiated from each other more easily.

The cross-sectional area of the flow channel P2, except for the gap G, may be substantially constant from the side of the inlet channel P1 to the side of the return channel P4. As shown in FIG. 21, for example, a height H1 of the flow channel P2 at the side of the inlet channel P1 may be higher than a height H2 thereof at the side of the return channel P4, and the height of the flow channel P2 may gradually decrease from the side of the inlet channel P1 toward the side of the return channel P4. With this configuration, the cross-sectional area of the flow channel P2, except for the gap G, may be made substantially constant.

In the case where the base head 32a is bonded onto the support 32b with an adhesive, the upper surface of the support 32b may serve as a bonding surface. If this is the case, as shown in FIG. 22, a bonding layer 33 may be provided over the topmost surface of the large-diameter portion 32b1 of the support 32b. In FIG. 22, the bonding layer 33 is shown with smudging. Further, in FIG. 22, the outline of the base 32a1 is shown with a dashed-two-dotted line.

The flat mirror 30 provided with the above-described flow channel FP may be cooled by making the heat medium flow in the flow channel FP. With this, a rise in the temperature in the flat mirror 30 may be suppressed, and thermal deformation in the reflective surface may be reduced. When, for example, the flat mirror 30 is used as the flat mirror 103 shown in FIG. 1, the thermal deformation in the reflective surface thereof can be reduced. Therefore, the laser beam LB2 having a desired beam profile may be focused in the plasma generation region PS with high accuracy and with high precision.

In the flat mirror 30, the buffer tank portion PB may be disposed, in its entirety, inside the support 32b. With this, compared to the case where part of the head cover is made to serve as part of a wall of the buffer tank portion PB, the buffer tank portion PB may be increased in volume more easily. Accordingly, even if the flow rate of the heat medium supplied into the flow channel FP is increased, a sudden fluctuation in pressure inside the flow channel FP caused when the heat medium starts or stops to be supplied into the flow channel FP may be reduced.

In the case where the flow channel P2 is sectoral in shape as viewed from above and the partition BH between the adjacent flow channels is rectangular parallelepiped in shape, compared to the case where the partition BH is sectoral in shape as viewed from above, the base head 32a may be easily cooled more uniformly by the heat medium flowing in the flow channels P2. As a result, the flat mirror 30 may be cooled uniformly more easily. In the case where the conical flow regulating portion 32a3 is provided to the base head 32a, the surface area of the base head 32a in which the base head 32a makes contact with the heat medium around the center thereof may be increased. As a result, compared to the case where the flow regulating portion 32a3 is not provided, the reflective surface may be cooled more effectively around the center thereof, in which the reflective surface may be heated more intensely by the laser beam incident thereon.

In the case where the cross-sectional area of the flow channel P2 is substantially constant from the side of the inlet channel P1 to the side of the return channel P4, compared to the case there the cross-sectional area varies, the flow rate of the heat medium may be less likely to drop at the side of the return channel P4. As a result, the temperature distribution in the reflective surface may be made more uniform. Further, disposing the flat mirror 30 such that the center of the radially-disposed flow channels P2 substantially coincides with the beam axis of the laser beam to be reflected thereby may make the temperature distribution in the reflective surface substantially point-symmetric with respect to the center thereof. In this case, the wavefront of the laser beam reflected by the flat mirror 30 may be likely to be corrected easily with an adaptive optics.

Configuring the return channel P4 such that the cross section thereof is an elongated hole in shape, as described above, at the side of the flow channel P2 may reduce accumulation of the heat medium in the flow channel P2. Further, providing the projection 32a2 on the base head 32a may make it possible to make the partition BH higher than the flow channel P2 with the gap G not being included. As a result, when the base head 32a and the support 32b are bonded to each other with an adhesive, an unhardened adhesive may be prevented from permeating into the flow channel P2 with capillarity causing the flow channel P2 to be clogged.

As in the flat mirror 1 according to the first embodiment, the flat mirror 30 may be combined with a given pipe, a pressure-feed device, a cooling device for cooling the heat medium, and so forth, to constitute a mirror device. The mirror device including the flat mirror 30 may be configured similarly to the mirror device 200, except in that the flat mirror 1 in the mirror device 200 is replaced by the flat mirror 30.

### Fourth Embodiment

A flow channel including a plurality of flow channels disposed radially and a buffer tank portion may be provided, aside from a flat mirror, in a concave mirror, a convex mirror, and so forth.

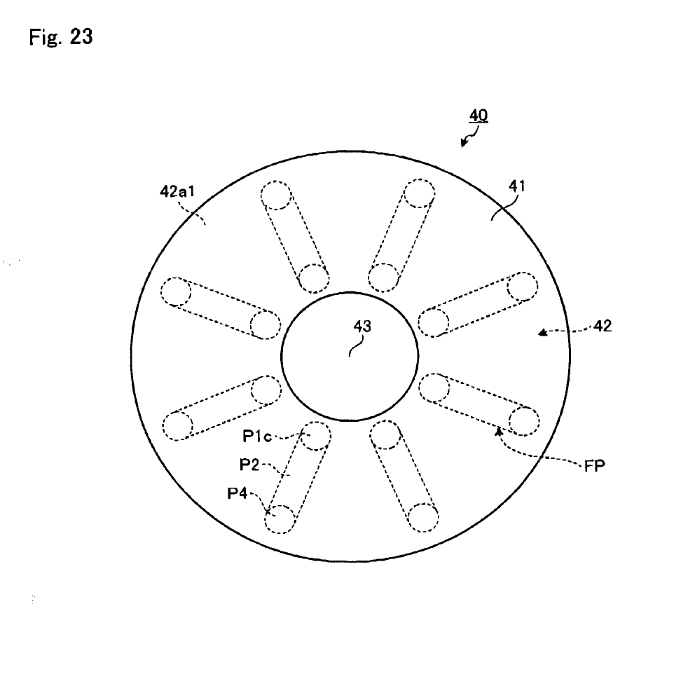

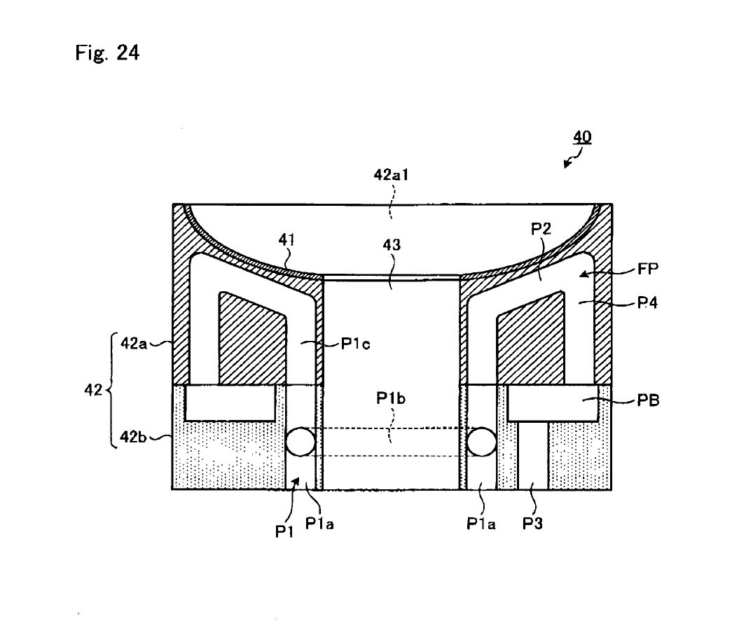

FIG. 23 is a plan view schematically illustrating an example of a circular concave mirror according to a fourth embodiment of this disclosure. FIG. 24 is a longitudinal sectional view schematically illustrating the configuration of the concave mirror illustrated in FIG. 23. As shown in FIGS. 23 and 24, a concave mirror 40 may include a mirror base 42 and a reflective film 41. The reflective film 41 may be formed on the upper surface side of the mirror base 42. The reflective film 41 may be a multilayer reflective film, for example. The mirror base 42 may include a base head 42a and a columnar support 42b. The base head 42a may include a recess 42a1 upon which the reflective film 41 is formed. The support 42b may be bonded to the base head 42a. The base head 42a and the support 42b may be made of a metallic material, such as nickel, for example. A through-hole 43 may be provided in the reflective film 41 and the mirror base 42 so as to pass therethrough. In FIG. 24, the section of the support 42b is smudged.

As will be described below, a flow channel configured similarly to the flow channel FP shown in FIG. 2 may be provided inside the mirror base 42, for example. In the description to follow, of the two end surfaces of the mirror base 42 in the thickness direction thereof, a side on which the recess 42a1 is formed is referred to as an “upper surface,” and the other side is referred to as a “lower surface.”

As shown in FIGS. 23 and 24, the flow channel FP inside the mirror base 42 may include the inlet channel P1, the flow channels P2, the return channels P4, the buffer tank portion PB, and the outlet channel P3. The inlet channel P1 may serve as a path along which the heat medium supplied from the heat medium supply source may flow into the mirror base 42. The flow channels P2 may branch off radially from the inlet channel P1. With this, the heat medium may flow substantially uniformly along the upper surface side of the mirror base 42. The return channels P4 may be connected to the flow channels P2, respectively. The buffer tank portion PB may be connected to the return channels P4. The outlet channel P3 may serve as a path along which the heat medium having flowed into the buffer tank portion PB may flow out of the mirror base 42.

In the case where the through-hole 43 is provided in the mirror base 42, as shown in FIGS. 23 and 24, the inlet channel P1 may include at least one supply source side inlet channel P1a, a distribution flow channel P1b, and at least one reflective surface side inlet channel P1c. The supply source side inlet channel P1a may be connected, at one end thereof, to the supply source of the heat medium. The distribution flow channel P1b may be disposed so as to surround the through-hole 43 and connected to the other end of the supply source side inlet channel P1a. The reflective surface side inlet channel P1c may be connected, at one end thereof, to the distribution flow channel P1b and, at the other end thereof, to the flow channel P2.

The inlet channel P1 may open, at one end thereof, in a surface of the mirror base 42. In the case where the inlet channel P1 includes a plurality of the supply source side inlet channels P1a, the respective one ends of the supply source side inlet channels P1a may open in the surface of the mirror base 42. Similarly, in the case where the inlet channel P1 includes a plurality of the reflective surface side inlet channels P1c, the respective other ends of the reflective surface side inlet channels P1c may be connected to the respective flow channels P2 at the upper surface side of the mirror base 42.

The flow channels P2 may be disposed radially from the center of the mirror base 42. The flow channels P2 may extend from the side of the inlet channel P1 toward the periphery of the mirror base 42 along the upper surface thereof. The return channels P4 may be connected, at one ends thereof, to the flow channels P2, respectively, at the periphery side of the mirror base 42. The return channels P4 may extend, at the other ends thereof, toward the lower surface side of the mirror base 42 and be connected to the buffer tank portion PB.

The buffer tank portion PB, to which the return channels P4 are connected, may be provided so as to make the flow rate of the heat medium in the flow channels P2 and the return channels P4, respectively, substantially uniform. Providing the buffer tank portion PB may allow pressure drops caused when the heat medium flows in the flow channels P2 and the return channels P4 to be made substantially uniform. Further, the buffer tank portion PB may be provided so as to absorb pressure fluctuation of the heat medium flowing in the flow channels P2 and the return channels P4. The buffer tank portion PB may be larger in cross-sectional area than the entire flow channels P2. As shown in FIG. 24, the buffer tank portion PB may be realized with an annular space defined in the mirror base 42.

The outlet channel P3 may be connected, at one end thereof, to the buffer tank portion PB, and open, at the other end thereof, in the surface of the mirror base 42. As shown in FIG. 24, the outlet channel P3 may open in the lower surface of the support 42b. In this case, the outlet for the heat medium may be the opening in the outlet channel P3 provided in the lower surface of the support 42b.

The concave mirror 40 provided with the above-described flow channel FP may be cooled by making the heat medium flow in the flow channel FP. With this, a rise in the temperature in the concave mirror 40 may be suppressed, and thermal deformation in the reflective surface may be reduced. When, for example, the concave mirror 40 is used as the EUV collector mirror 122 shown in FIG. 1, the thermal deformation in the reflective surface thereof can be reduced. Accordingly, the EUV light L having a desired profile may be focused on the intermediate focus IF with high accuracy and with high precision. As in the flat mirror 1 according to the first embodiment, the concave mirror 40 may be combined with a given pipe, a pressure-feed device, a cooling device for cooling the heat medium to constitute a mirror device.

### Fifth Embodiment

In a mirror device including a mirror provided with a flow channel thereinside, a pressure-feed device may be disposed either upstream or downstream of the mirror, or two pressure-feed devices may be disposed respectively both upstream and downstream of the mirror.

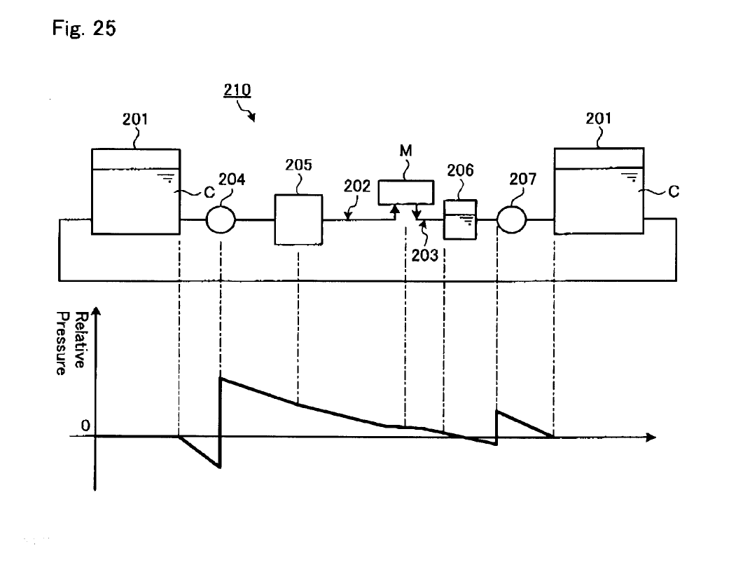

FIG. 25 schematically illustrates an example of the mirror device and pressure applied to the heat medium at each location in the mirror device according to a fifth embodiment of this disclosure. A mirror device 210 shown in FIG. 25 is similar in configuration to the mirror device 200 shown in FIG. 7 except in that a buffer tank 206 and a discharge pressure-feed device 207 are provided downstream of a mirror M to be cooled in the mirror device 210. Inside the mirror M, the flow channel FP shown in FIG. 2 and the flow channel FP shown in FIG. 24 may be provided. Of the constituent elements shown in FIG. 25, constituent elements similar to those shown in FIG. 7 will be referenced by like referential symbols and the duplicate descriptions thereof will be omitted.

In the mirror device 210, actuating at least one of the pressure-feed device 204 and the discharge pressure-feed device 207 may cause the heat medium C inside the heat medium supply source 201 to flow into the flow channel inside the mirror M via the supply pipe 202, and into the discharge pipe 203 via the flow channel inside the mirror M. Thereafter, the heat medium C may be stored once in the buffer tank 206 and then may return to the heat medium supply source 201. The heat medium C may be used repeatedly.

As shown in FIG. 25, in the case where the pressure-feed device 204 and the discharge pressure-feed device 207 are both actuated, the relative pressure inside the mirror device 210 with respect to the atmospheric pressure may be at the lowest in the pressure-feed device 204 before the pressure-feed device 204 is actuated. Further, the relative pressure may be at the highest in the pressure-feed device 204 after the pressure feed device 204 is actuated. When the relative pressure inside the heat medium supply source 201 with respect to the atmospheric pressure is assumed to be 0, the relative pressure inside the mirror device 210 may decrease toward the pressure-feed device 204. Then, the heat medium C having reached the pressure-feed device 204 may have the pressure thereof raised in the pressure-feed device 204.

Then, the relative pressure inside the mirror device 210 may gradually decrease from the pressure-feed device 204 toward the cooling device 205, the flow channel in the mirror M, the buffer tank 26, and the discharge pressure-feed device 207. The discharge pressure-feed device 207 may suck the heat medium C. In this case, the relative pressure inside the mirror device 210 may be in a negative value between the buffer tank 206 and the discharge pressure-feed device 207. Further, the discharge pressure-feed device 207 may be configured to raise the pressure of the heat medium C. If this is the case, the relative pressure inside the mirror device 210 may be in a positive value after the pressure of the heat medium C is raised in the discharge pressure-feed device 207. Thereafter, the relative pressure may gradually decrease from the discharge pressure-feed device 207 toward the heat medium supply source 201. The relative pressure may become 0 in the heat medium supply source 201.

When, in addition to at least one of the pressure-feed device 204 and the discharge pressure-feed device 207, the cooling device 205 is actuated, and the heat medium C having been cooled in the cooling device 205 may be supplied into the flow channel in the mirror M via the supply pipe 202. As a result, compared to the case where at least one of the pressure-feed device 204 and the discharge pressure-feed device 207 is actuated but the cooling device 205 is not actuated, the mirror M may be cooled more efficiently.

In the mirror device 210, both the pressure-feed device 204 and the discharge pressure-feed device 207 may be actuated to thereby cause the heat medium C to flow in the flow channel inside the mirror M. With this, compared to the case where only one of the pressure-feed device 204 and the discharge pressure-feed device 207 is actuated to cause the heat medium C to flow in the flow channel inside the mirror M, the relative pressure in the flow channel inside the mirror M may be further reduced. Further, the buffer tank 206 is provided between the mirror M and the discharge pressure-feed device 207; therefore, even when the flow channel inside the mirror M is provided closely to the reflective film, vibration due to the pressure fluctuation caused to the reflective film as the heat medium C flows in the flow channel may be reduced.

### Sixth Embodiment

The mirror and the mirror device of this disclosure may be used as a constituent element of various laser apparatuses. The laser apparatus may be a driver laser apparatus of an LPP type EUV light generation apparatus, a laser apparatus used in a laser processing device or the like, or a constituent element thereof. The mirror and the mirror device of this disclosure may be a constituent element disposed on a laser beam delivery path.

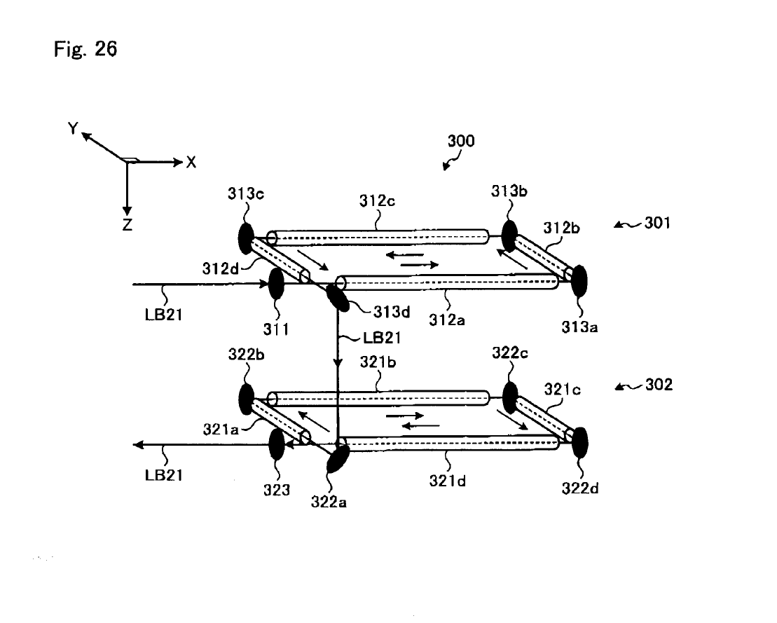

FIG. 26 schematically illustrates an example of an amplifier of a laser apparatus according to a sixth embodiment of this disclosure. As shown in FIG. 26, an amplifier 300 may include a first discharge unit 301 and a second discharge unit 302. When the amplifier 300 is configured in this way, the first discharge unit 301 may include a window 311, four discharge tubes 312a through 312d, and four mirror devices 313a through 313d. The second discharge unit 302 may include four discharge tubes 321a through 321d, four mirror devices 322a through 322d, and a window 323. The mirror devices 313a through 313d and 322a through 322d may be the mirror device of this disclosure.

The discharge tubes 312a through 312d and 321a through 321d may be filled with a gas laser medium. The discharge tubes 312a through 312d and 321a through 321d may be provided a pair of electrodes, respectively, and voltage may be applied between the pair of the electrodes by a power source (not shown) at predetermined timing. The application of the voltage may cause the discharge to occur, whereby the gas laser medium may be excited. The gas laser medium may include carbon dioxide (CO₂), nitrogen (N₂), helium (He), and so forth. Further, the gas laser medium may include hydrogen (H₂), carbon monoxide (CO), xenon (Xe), and so forth, as necessary.

In the amplifier 300 configured as described above, a laser beam LB21 transmitted through the window 311 may be amplified in the first discharge unit 301 and the second discharge unit 302. In this case, the laser beam LB21 transmitted through the window 311 may enter the discharge tube 312a and be amplified therein. Then, the laser beam LB21 may be reflected in the Y-direction by the mirror device 313a, enter the discharge tube 312b, and be amplified therein. The laser beam LB21 amplified in the discharge tube 312b may then be reflected in the X-direction by the mirror device 313b, enter the discharge tube 312c, and be amplified therein. The laser beam LB21 amplified in the discharge tube 312c may then be reflected in the Y-direction by the mirror device 313c, enter the discharge tube 312d, and be amplified therein.

The laser beam LB21 amplified in the discharge tube 312d may then be reflected in the Z-direction by the mirror device 313d and be propagated to the second discharge unit 302. Subsequently, the laser beam LB21 may be reflected in the Y-direction by the mirror device 322a, enter the discharge tube 321a, and be amplified therein. The laser beam LB21 amplified in the discharge tube 321a may then be reflected in the X-direction by the mirror device 322b, enter the discharge tube 321b, and be amplified therein. The laser beam LB21 amplified in the discharge tube 321b may then be reflected in the Y-direction by the mirror device 322c, enter the discharge tube 321c, and be amplified therein. The laser beam LB21 amplified in the discharge tube 321c may then be reflected in the X-direction by the mirror device 322d, enter the discharge tube 321d, and be amplified therein.

The laser beam LB21 amplified in the second discharge unit 302 may be transmitted through the window 323 and be outputted from the amplifier 300. The X-, Y-, and Z-coordinate axes are shown in FIG. 26. Further, solid arrows indicate the direction of the laser beam LB21 in the discharge tubes 312a through 312d and 321a through 321d, respectively.

In the amplifier 300 described above, the mirror device of this disclosure may be used for the mirror devices 313a through 313d and 322a through 322d. This may reduce the possibility of the beam profile of the laser beam LB21 being changed from the desired beam profile along the amplification process.

### Seventh Embodiment

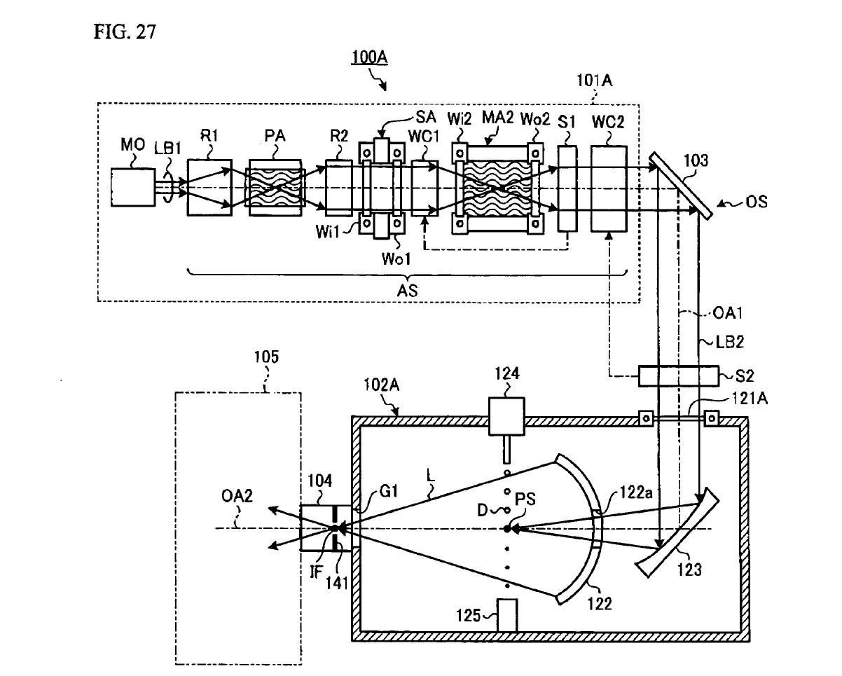

The mirror and the mirror device of this disclosure may serve as a constituent element of various apparatuses including an optical system. FIG. 27 schematically illustrates an example of an EUV light generation system according to a seventh embodiment of this disclosure. An EUV light generation system 100A shown in FIG. 27 may include a driver laser apparatus 101A in place of the driver laser system 101 shown in FIG. 1. Further, the EUV light generation system 100A may include a chamber 102A in place of the chamber 102 shown in FIG. 1. Furthermore, the EUV light generation system 100A may include a wavefront sensor S2.

The driver laser apparatus 101A may include a main amplifier MA2 in place of the main amplifier MA shown in FIG. 1, for example. Further, the driver laser apparatus 101A may include a saturable absorber cell SA and a wavefront correction unit WC1 disposed, between the main amplifier MA2 and the relay optical system R2, in this order from the side of the relay optical system R2. Furthermore, the driver laser apparatus 101A may include a wavefront sensor S1 and a wavefront correction unit WC2 in place of the relay optical system R3 shown in FIG. 1. Of the constituent elements shown in FIG. 27, the constituent elements common to those shown in FIG. 1 may be referenced by like referential symbols used in FIG. 1, and the duplicate description thereof will be omitted.

The saturable absorber cell SA may include sulfur hexafluoride (SF6) gas as a saturable absorber. The saturable absorber may absorb a laser beam LB1 of at or below a predetermined intensity and transmit a laser beam LB1 of above the predetermined intensity. Disposing such saturable absorber cell SA may prevent the laser beam LB1 of at or below the predetermined intensity from entering the main amplifier MA2. With this, self-oscillation of the main amplifier MA2 may be suppressed. The saturable absorber cell SA may be disposed for absorbing light reflected by an optical system disposed on a beam path of the laser beam LB1 or by the droplet D serving as the target material. Further, the saturable absorber cell SA may include a beam input window Wi1 and a beam output window Wo1. The beam input window Wi1 and the beam output window Wo1 may be configured such that a window material thereof can be cooled by making a heat medium flow in a flow channel provided in a window frame thereof.

The main amplifier MA2 may include a beam input window Wi2 and a beam output window Wo2. The beam input window Wi2 and the beam output window Wo2 may be configured such that the window material thereof can be cooled by making a heat medium flow in a flow channel provided in the window frame thereof. The wavefront sensor S1 may detect a wavefront WF of the laser beam LB1 outputted from the main amplifier MA2. The wavefront sensor S1 may input the detected result to the wavefront correction unit WC1. The wavefront correction unit WC1 may correct the wavefront of the laser beam LB1 entering the main amplifier MA2, based on the detected result by the wavefront sensor S1. The wavefront correction unit WC1 may correct the wavefront of the laser beam LB1 such that the wavefront WF of the laser beam LB1 outputted from the main amplifier MA2 is in a predetermined shape.

The chamber 102A may include a window 121A. The window 121A may be configured such that the window material thereof can be cooled by making a heat medium flow in a flow channel provided in the window frame thereof. The chamber 102A may be configured similarly to the chamber 102 shown in FIG. 1 except for the window 121A.

The wavefront sensor S2 may be disposed between the window 121A of the chamber 102A and the flat mirror 103. The wavefront sensor S2 may detect the wavefront WF of the laser beam LB2 reflected by the flat mirror 103. The wavefront sensor S2 may input the detected result to the wavefront correction unit WC2.

In the EUV light generation system 100A described above, at least one of the flat mirror 103, the EUV collector mirror 122, and the off-axis paraboloidal mirror 123 may be provided with the flow channel according to the above embodiments. When a mirror is used as a constituent element in any of the preamplifier PA, the wavefront correction unit WC1, the main amplifier MA2, and the wavefront correction unit WC2, the mirror may be provided with the flow channel according to the above embodiments. Providing the mirror with the flow channel according to the above embodiments and allowing the heat medium to flow in the flow channel may make it possible to cool the reflective surface of the mirror substantially uniformly and point-symmetrically. Cooling the mirror on which the laser beam LB1 or LB2 or the EUV light L may be incident and preventing the temperature of the reflective surface of the mirror from being increased may suppress the thermal deformation in the reflective surfaces thereof. With this, the laser beam LB1 or LB2 or the EUV light L may be reflected with the wavefront thereof being prevented from being deformed. Accordingly, the laser beam LB2 having a desired beam profile may be focused precisely and accurately on the plasma generation region PS. Alternatively, the EUV light L having a desired profile may be focused precisely and accurately on the intermediate focus IF. As a result, the energy conversion efficiency in the EUV light generation system 100A may be improved.

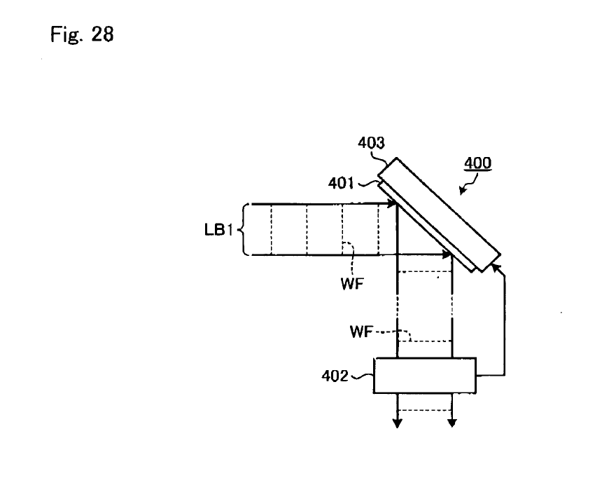

When the saturable absorber cell SA includes the beam input window Wi1 and the beam output window Wo1 and the axis of the incident beam on the windows Wi1 and Wo1 substantially coincides with the center of the windows Wi1 and Wo1, the windows Wi1 and Wo1 may be cooled by making a heat medium flow in the flow channel provided in the window frames thereof. With this, the heat distribution in the windows Wi1 and Wo1 may be made substantially point-symmetric about the center of the windows Wi1 and Wo1. Similarly, when the main amplifier MA2 includes the beam input window Wi2 and the beam output window Wo2 and the axis of the incident beam on the windows Wi2 and Wo2 substantially coincides with the center of the windows Wi2 and Wo2, the windows Wi2 and Wo2 may be cooled by making a heat medium flow in the flow channel provided in the window frames thereof. With this, the heat distribution in the windows Wi2 and Wo2 may be made substantially point-symmetric about the center of the windows Wi2 and Wo2. Further, when the chamber 102A includes the window 121A and the axis of the incident beam on the window 121A substantially coincides with the center of the window 121A, the window 121A may be cooled by making a heat medium flow in the flow channel provided in the window frame thereof. With this, the heat distribution in the window 121A may be made substantially point-symmetric about the center of the window 121A. In these cases, the wavefront WF of the laser beam LB1 or the laser beam LB2 may be corrected easily with a wavefront correction device provided with a wavefront correction unit including an optical element, such as a deformable mirror, having a simple configuration. Hereinafter, illustrating a case in which the wavefront of the laser beam LB1 is corrected, a wavefront correction device, which may serve as a constituent element of the laser apparatus or of the EUV light generation apparatus of this disclosure, will be described in detail with reference to FIGS. 28 through 39.

FIGS. 28 through 30 schematically illustrate operation states in an example of the wavefront correction device, which may serve as a constituent element of the laser apparatus or of the EUV light generation apparatus of this disclosure. A wavefront correction device 400 shown in FIGS. 28 through 30 may include a deformable mirror 401, a wavefront sensor 402, and a mirror actuator 403. The deformable mirror 401 may be capable of having the curvature of the reflective surface thereof be modified. The wavefront sensor 402 may detect the wavefront WF of the laser beam LB1 reflected by the deformable mirror 401. The mirror actuator 403 may modify the curvature of the reflective surface of the deformable mirror 401 based on the wavefront WF of the laser beam LB1 detected by the wavefront sensor 402. The deformable mirror 401 may be disposed such that the laser beam LB1 is incident thereon at an incident angle of 45 degrees when the reflective surface thereof is flat.

When the wavefront WF of the laser beam LB1 detected by the wavefront sensor 402 is flat, the mirror actuator 403 may control the shape of the reflective surface of the deformable mirror 401 such that the reflective surface of the deformable mirror 401 is maintained to be flat, as shown in FIG. 28.

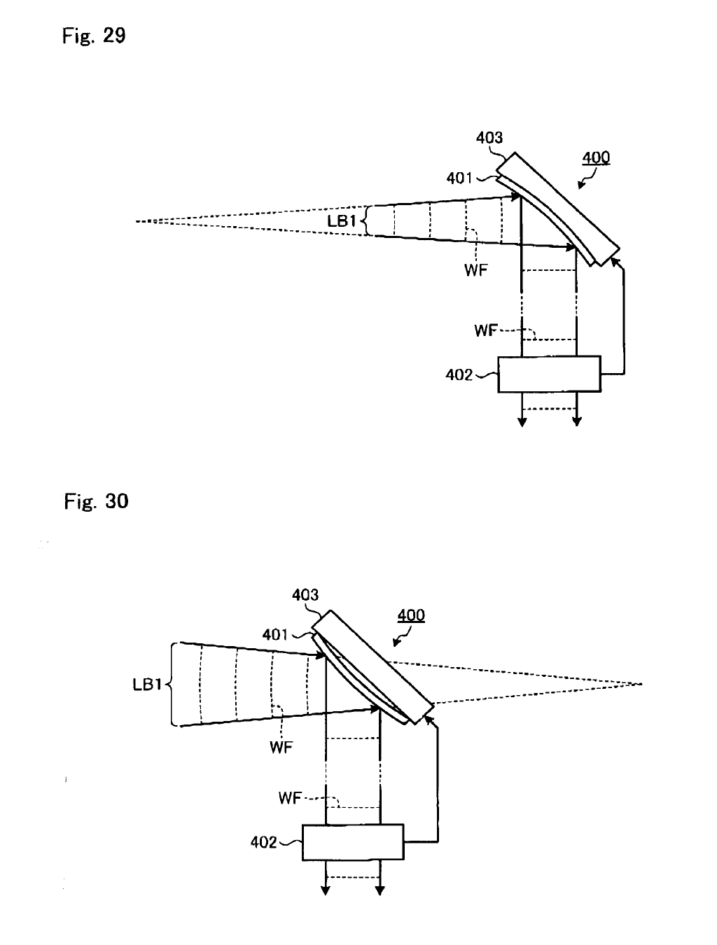

When the wavefront WF of the laser beam LB1 detected by the wavefront sensor 402 is convex, the mirror actuator 403 may control the shape of the reflective surface of the deformable mirror 401 such that the wavefront WF of the laser beam LB1 to be detected by the wavefront sensor 402 is flat, as shown in FIG. 29.

When the wavefront WF of the laser beam LB1 detected by the wavefront sensor 402 is concave, the mirror actuator 403 may control the shape of the reflective surface of the deformable mirror 401 such that the wavefront WF of the laser beam LB1 to be detected by the wavefront sensor 402 is flat, as shown in FIG. 30.

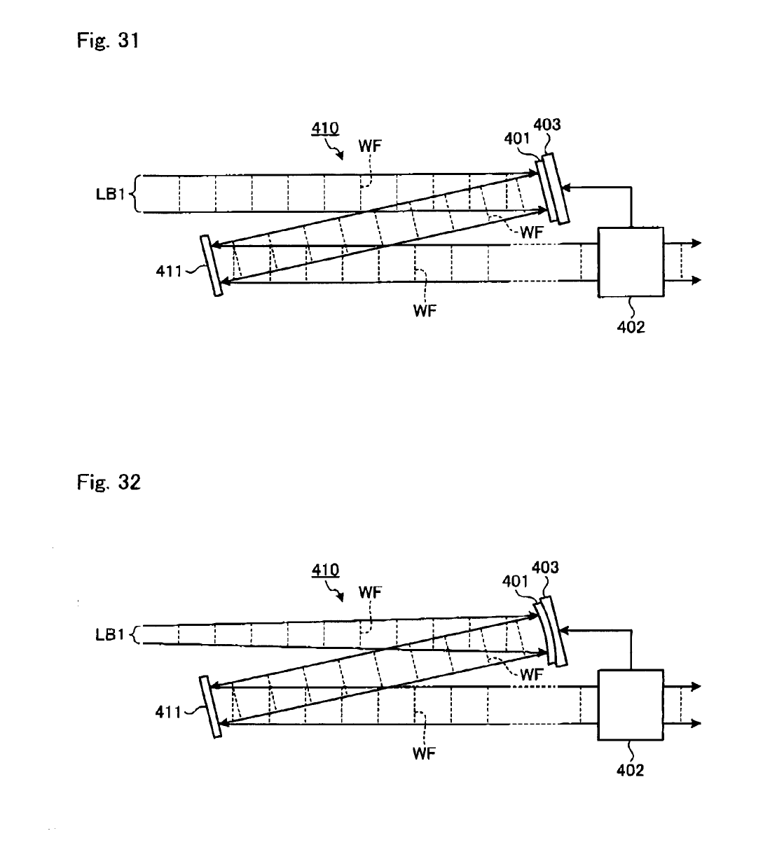

FIGS. 31 through 33 schematically illustrate operation states in another example of the wavefront correction device, which may serve as a constituent element of the laser apparatus or of the EUV light generation apparatus of this disclosure. A wavefront correction device 410 shown in FIGS. 31 through 33 may include a deformable mirror 401, a flat mirror 411, a wavefront sensor 402, and a mirror actuator 403. The deformable mirror 401 may be capable of having the curvature of the reflective surface thereof be modified. The flat mirror 411 may reflect the laser beam LB1 reflected by the deformable mirror 401. The wavefront sensor 402 may detect the wavefront WF of the laser beam LB1 reflected by the flat mirror 411. The mirror actuator 403 may modify the curvature of the reflective surface of the deformable mirror 401 based on the wavefront WF of the laser beam LB1 detected by the wavefront sensor 402.

In the wavefront correction device 410, the deformable mirror 401 and the flat mirror 411 may function as a Z-fold adaptive mirror. In this case, the deformable mirror 401 may be disposed such that the laser beam LB1 may be incident thereon at a predetermined incident angle (2.5 degrees, for example). The flat mirror 411 may be disposed such that the beam axis of the laser beam LB1 reflected by the flat mirror 411 may be substantially parallel with the beam axis of the laser beam LB1 incident on the deformable mirror 401 and the laser beam LB1 may be incident on the flat mirror 411 at an incident angle of 2.5 degrees, for example.

When the wavefront WF of the laser beam LB1 detected by the wavefront sensor 402 is flat, the mirror actuator 403 may control the shape of the reflective surface of the deformable mirror 401 such that the reflective surface of the deformable mirror 401 is maintained to be flat, as shown in FIG. 31.

When the wavefront WF of the laser beam LB1 detected by the wavefront sensor 402 is convex, the mirror actuator 403 may control the shape of the reflective surface of the deformable mirror 401 such that the wavefront WF of the laser beam LB1 to be detected by the wavefront sensor 402 is flat, as shown in FIG. 32.

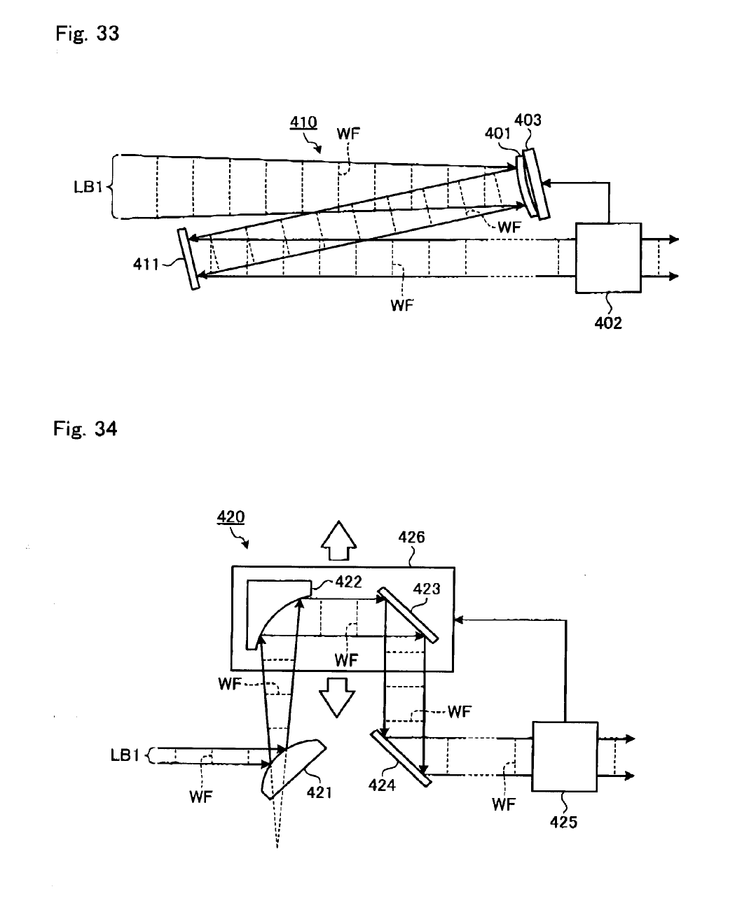

When the wavefront WF of the laser beam LB1 detected by the wavefront sensor 402 is concave, the mirror actuator 403 may control the shape of the reflective surface of the deformable mirror 401 such that the wavefront WF of the laser beam LB1 to be detected by the wavefront sensor 402 is flat, as shown in FIG. 33.

FIG. 34 schematically illustrates yet another example of the wavefront correction device, which may serve as a constituent element of the laser apparatus or of the EUV light generation apparatus of this disclosure. A wavefront correction device 420 shown in FIG. 34 may include a convex mirror 421, a concave mirror 422, two flat mirrors 423 and 424, and a wavefront sensor 425. The convex mirror 421 may expand the beam diameter of the laser beam LB1. The concave mirror 422 may collimate the laser beam LB1 of which the beam diameter has been expanded. The two flat mirrors 423 and 424 may put the beam axis of the collimated laser beam LB1 back onto an extension of the beam axis of the laser beam LB1 incident on the convex mirror 421. The wavefront sensor 425 may detect the wavefront WF of the laser beam LB1 reflected by the flat mirror 424. In this configuration, the concave mirror 422 and the flat mirror 423 may be mounted on a movable plate 426, for example. The movable plate 426 may include a moving mechanism (not shown). The moving mechanism may cause the movable plate 425 to move in the direction shown in the white arrow, based on the wavefront WF of the laser beam LB1 detected by the wavefront sensor 425. With this, the distance between the convex mirror 421 and the concave mirror 422 may be changed. As a result, the wavefront WF of the laser beam LB1 may be corrected.

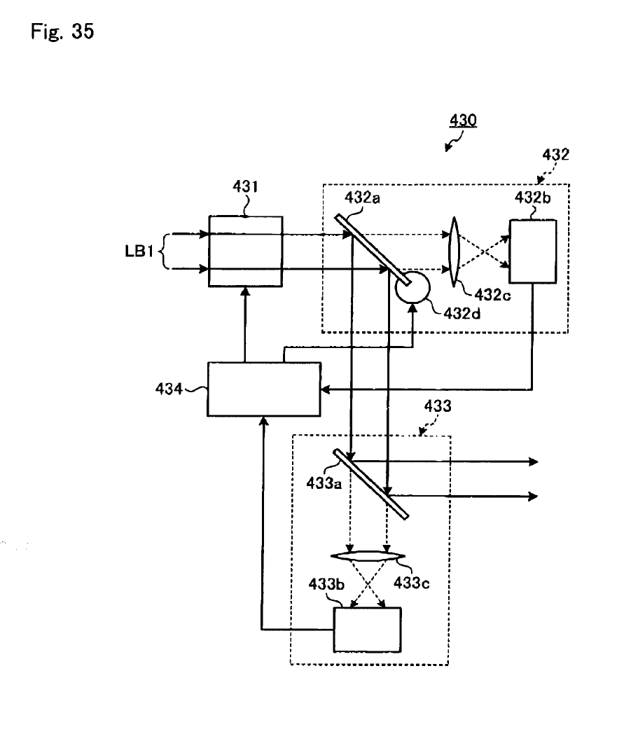

FIG. 35 schematically illustrates yet another example of the wavefront correction device, which may serve as a constituent element of the laser apparatus or of the EUV light generation apparatus of this disclosure. A wavefront correction device 430 shown in FIG. 35 may include a wavefront correction unit 431, two wavefront measuring units 432 and 433, and a wavefront correction unit controller 434. The wavefront correction unit controller 434 may control the operation of the wavefront correction unit 431 based on the measurement result by the wavefront measuring units 432 and 433.

The wavefront correction unit 431 may include the deformable mirror 401 shown in FIGS. 28 through 30, for example. Alternatively, the wavefront correction unit 431 may include the deformable mirror 401 and the flat mirror 411 shown in FIGS. 31 through 33. Further alternatively, the wavefront correction unit 431 may include the convex mirror 421, the concave mirror 422, the two flat mirrors 423 and 424, and the movable plate 426 shown in FIG. 34.

The wavefront measuring unit 432 may include a beam sampler 432a, a beam profiler 432b, and a lens 432c. The beam sampler 432a may reflect part of the laser beam LB1 outputted from the wavefront correction unit 431 and transmit the other part thereof. The beam profiler 432b may measure the beam profile of the laser beam LB1. The lens 432c may transfer the image of the laser beam LB1 transmitted through the beam sampler 432a onto a photosensitive surface of the beam profiler 432b. Similarly, the wavefront measuring unit 433 may include a beam sampler 433a, a beam profiler 433b, and a lens 433c. The beam sampler 433a may reflect part of the laser beam LB1 reflected by the beam sampler 432a and transmit the other part thereof. The beam profiler 433b may measure the beam profile of the laser beam LB1. The lens 433c may transfer the image of the laser beam LB1 transmitted through the beam sampler 433a onto a photosensitive surface of the beam profiler 433b.

The measurement results by the beam profilers 432b and 433b may respectively be inputted to the wavefront correction unit controller 434. The wavefront correction unit controller 434 may control the wavefront correction unit 431, based on at least one of the inputted measurement results, so that the wavefront of the laser beam LB1 becomes flat, for example.

The wavefront correction device 430 may be provided with a mirror actuator 432d for controlling the incident angle of the laser beam LB1 onto the beam sampler 432a. The mirror actuator 432d may control the tilt angle of the beam sampler 432a under the control of the wavefront correction unit controller 434. The wavefront correction unit controller 434 may actuate the mirror actuator 432d base on at least one of the measurement results inputted respectively from the beam profilers 432b and 433b. The wavefront correction unit controller 434 may actuate the mirror actuator 432d so that the laser beam LB1 outputted from the upstream wavefront measuring unit 432 is incident on the downstream wavefront measuring unit 433 at a more appropriate angle.

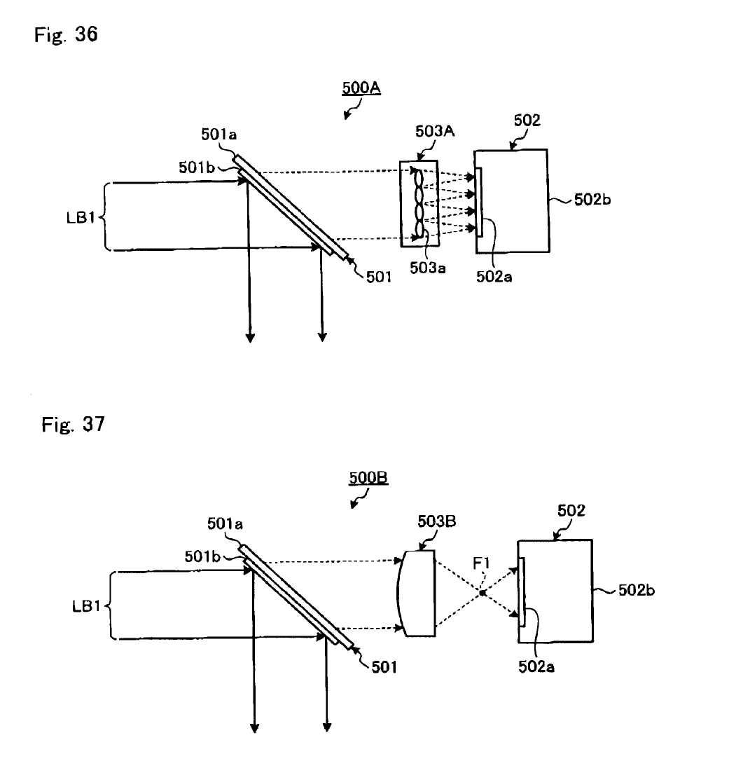

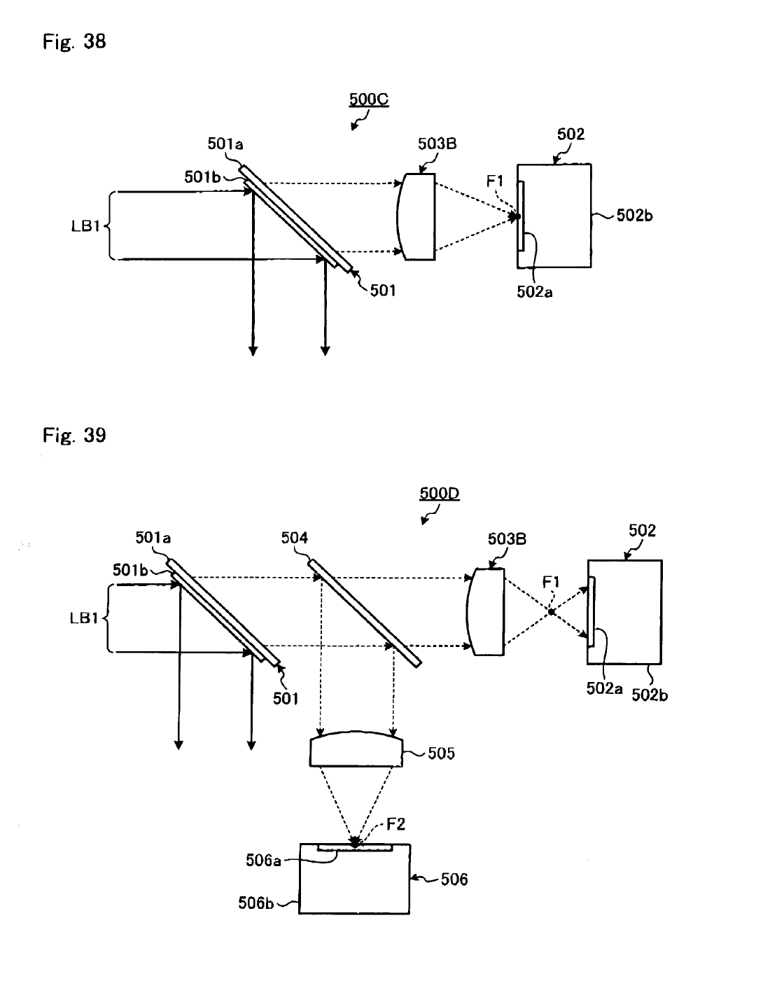

The wavefront measuring units 432 and 433 shown in FIG. 35 may respectively be configured as shown in FIGS. 36 through 39. FIG. 36 illustrates the configuration of another wavefront measuring unit of the wavefront correction device, which may serve as a constituent element of the laser apparatus or of the EUV light generation apparatus of this disclosure. FIG. 37 illustrates the configuration of yet another wavefront measuring unit of the wavefront correction device, which may serve as a constituent element of the laser apparatus or of the EUV light generation apparatus of this disclosure. FIG. 38 illustrates the configuration of yet another wavefront measuring unit of the wavefront correction device, which may serve as a constituent element of the laser apparatus or of the EUV light generation apparatus of this disclosure. FIG. 39 illustrates the configuration of still another wavefront measuring unit of the wavefront correction device, which may serve as a constituent element of the laser apparatus or of the EUV light generation apparatus of this disclosure.

The wavefront measuring unit 432 may be configured similarly to the wavefront measuring unit 433 except in that the wavefront measuring unit 432 may be provided with the mirror actuator 432d. Hereinafter, the configuration of the wavefront measuring unit 432 will described. For the sake of simplifying the description, the mirror actuator 432d will be omitted.

A wavefront measuring unit 500A shown in FIG. 36 may include a beam sampler 501, an infrared camera 502, and a microlens array 503A. The beam sampler 501 may transmit part of the laser beam LB1 and reflect the other part thereof. The infrared camera 502 may function as a beam profiler. The microlens array 503A may focus the laser beam LB1 transmitted through the beam sampler 501 into a plurality of images. The beam sampler 501 may include a transparent substrate 501a and a beam sampler coating 501b. The transparent substrate 501a may transmit the laser beam LB1. The beam sampler coating 501b may be provided on a surface of the beam sampler 501 on which the laser beam LB1 is incident. The beam sampler coating 501b may reflect part of the laser beam LB1 and transmit the other part thereof. The microlens array 503A may be configured of a plurality of microlenses 503a arranged two-dimensionally. The infrared camera 502 may include a body capturing unit 502a and an image data generation unit 502b. The body capturing unit 502a may capture a two-dimensional image of the laser beam LB1 focused by the microlens array 503A. The image data generation unit 502b may process the data captured by the body capturing unit 502a and generate an image data. In this way, the wavefront measuring unit 432 may be a so-called Shack-Hartmann wavefront sensor.

In a wavefront measuring unit 500B shown in FIG. 37, the microlens array 503A of the wavefront measuring unit 500A shown in FIG. 36 may be replaced by a convex lens 503B. The infrared camera 502 may be disposed farther from the convex lens 5038 than the focus F1 of the convex lens 503B. The laser beam LB1 may be focused by the convex lens 503B and then diverge, and may be incident on the photosensitive surface of the infrared camera 502. The wavefront measuring unit 500B may measure the beam profile of the laser beam LB1.

In a wavefront measuring unit 500C shown in FIG. 38, the infrared camera 502 may be disposed such that the focus F1 of the convex lens 503B of the wavefront measuring unit 500B shown in FIG. 37 lies on the photosensitive surface of the infrared camera 502. The wavefront measuring unit 500C may measure the beam waist of the laser beam LB1. Based on the measurement result, the shape of the beam waist of the laser beam LB1 may be adjusted by controlling the operation of the wavefront correction unit 431 shown in FIG. 35, for example.

A wavefront measuring unit 500D shown in FIG. 39 may include the function of the wavefront measuring unit 500B shown in FIG. 37 and the function of the wavefront measuring unit 500C shown in FIG. 38. The wavefront measuring unit 500D may be provided with a beam splitter 504 disposed between the beam sampler 501 and the convex lens 503B of the wavefront measuring unit 500B. The wavefront measuring unit 500D may further include a convex lens 505 and an infrared camera 506. The convex lens 505 may focus the laser beam LB1 reflected by the beam splitter 504. The infrared camera 506 may be disposed such that the focus F2 of the convex lens 505 lies on the photosensitive surface of the infrared camera 506.

The laser beam LB1 transmitted through the beam sampler 501 and the beam splitter 504 may be focused by the convex lens 503B and then diverge, and be incident on the photosensitive surface of the infrared camera 502. The laser beam LB1 transmitted through the beam sampler 501 and reflected by the beam splitter 504 may be focused by the convex lens 505 and be incident on the photosensitive surface of the infrared camera 506. The wavefront correction unit 431 shown in FIG. 35, for example, may be controlled based on the measurement result by the infrared camera 502. With this, the beam profile of the laser beam LB1 may be adjusted. Further, the wavefront correction unit 431 shown in FIG. 35, for example, may be controlled based on the measurement result by the infrared camera 506, whereby the beam waist of the laser beam LB1 may be adjusted.

So far, the mirror, the mirror device, the laser apparatus, and the EUV light generation system have been described while illustrating the embodiments. However, the embodiments described above are merely examples for implementing this disclosure, and this disclosure is not limited thereto. Making various modifications to the above-described embodiments is within the scope of this disclosure, and further, it is apparent from the above description that various other embodiments are possible within the scope of this disclosure.

For example, the planar shape of the reflective surface of the mirror provided with a flow channel thereinside may be in any shape, such as a polygon (for example, a square), an ellipse, or a circle. Further, one end of an inlet channel of a flow channel provided inside the mirror may open in a lower surface of the mirror base, or in a side surface of the mirror base. Similarly, one end of an outlet channel may open in a lower surface of the mirror base, or in a side surface of the mirror base. The planar shape of a buffer tank portion in a flow channel provided inside the mirror may be C-shaped.

In a mirror base provided with a planar base head and a support, as in the mirror base 32 of the flat mirror 30 shown in FIG. 16, planar projections corresponding to the flow channels disposed radially may be provided on the lower surface of the base head. When the projections are provided on the lower surface of the base head, the planar shape of the projections may be similar to the planar shape of the flow channels disposed radially. For example, when the planar shape of the flow channels disposed radially is rectangular in shape, the planar shape of the projections may also be rectangular in shape. Alternatively, the planar shape of the projections may not be similar to the planar shape of the flow channels disposed radially.

Further, whether or not a flow regulating portion may be provided at a location through which the heat medium flows from the inlet channel into the flow channels disposed radially is optional. The shape of the flow regulating portion, when the flow regulating portion is provided, is not limited to be conical in shape as shown in FIG. 16, but may be selected optionally.

A mirror device including a mirror provided with a flow channel thereinside as a constituent element may be a circulating type in which the heat medium used to cool the mirror is used repeatedly, or a non-circulating type in which the heat medium used to cool the mirror is not reused and is discarded. In a non-circulating type mirror device, a cooling device may be provided on a supply pipe connecting the heat medium supply source and the mirror. The cooling device may be configured not only to cool the heat medium but also to heat the heat medium as necessary so as to maintain the temperature of the heat medium constant. That is, the cooling device may be a temperature control device. With either a circulating or non-circulating type mirror device, the heat medium supply source and the other constituent elements may be distributed together or separately at a distribution stage. Further, at the distribution stage, the mirror device may not include the heat medium supply source and the heat medium. For example, the heat medium supply source and the heat medium may be separate from the mirror device.

In the mirror according to the embodiments of this disclosure, an outlet channel may be used as an inlet channel, or an inlet channel may be used as an outlet channel. Further, in a mirror device provided with a buffer tank on a discharge pipe thereof, as in the mirror device 210 shown in FIG. 25, a buffer tank portion inside the mirror may be omitted. In this case, the flow channels disposed radially may be in communication directly or indirectly with one or more discharge pipe(s). Further, a buffer tank may be provided in a supply pipe constituting the mirror device.

The mirror provided with the flow channel thereinside and the mirror device provided with such mirror may be used as a constituent element of various laser apparatuses, as has been described in the sixth embodiment. Such laser apparatuses may include a driver laser apparatus of an LPP type EUV light generation system, a laser apparatus used in a laser processing apparatus, and a constituent element thereof. Further, the mirror and the mirror device of this disclosure may be a constituent element disposed on a laser beam delivery path.

An EUV light generation system provided with the laser apparatus may be an LPP type EUV light generation system, as has been described in the first embodiment, or a DPP or an SR type EUV light generation system. Further, the EUV light generation system may be configured such that the target material is turned into plasma with single-stage laser irradiation or with multiple-stage laser irradiation.

When a wavefront sensor is provided in an EUV light generation system, the wavefront sensor may be disposed either inside or outside the chamber 102A shown in FIG. 27, for example. The wavefront sensor, for example, may be disposed either upstream or downstream side of he window 121A. Further, a wavefront correction unit and a wavefront sensor may be provided, without being limited to the input/output side of the main amplifier or the beam steering optical system constituting the driver laser apparatus, to the input/output side of the preamplifier, the saturable absorber cell, or the relay optical system. Furthermore, the wavefront correction unit and the wavefront sensor may be provided in pair for each optical system, such as the preamplifier and the main amplifier, or for a plurality of the optical elements.

The wavefront correction unit may include a deformable mirror in which the curvature of the entire reflective surface can be changed, or a deformable mirror in which the curvature of part of the reflective surface can be changed.

The terms used in this specification and the appended claims should be interpreted as “non-limiting.” For example, the terms “include” and “be included” should be interpreted as “not limited to the stated elements.” The term “have” should be interpreted as “not limited to the stated elements.” Further, the modifier “one (a/an)” should be interpreted as “at least one” or “one or more.”

What is claimed is:

1. A mirror, comprising:
a mirror base provided with a flow channel through which a heat medium passes for cooling the mirror, the flow channel including a buffer tank portion for adjusting a flow rate of the heat medium in the flow channel; and
a reflective film provided on the mirror base.

2. The mirror according to claim 1, wherein
the mirror base includes a base head and a support,
the reflective film is provided on the base head, and
the flow channel includes a first flow channel, a second flow channel, a third flow channel, and a fourth flow channel, the heat medium flowing through the first flow channel, the second flow channel, the fourth flow channel, the buffer tank portion, and the third flow channel in that order.

3. The mirror according to claim 2, wherein
the second flow channel comprises a plurality of sub-second flow channels, and
the plurality of the sub-second flow channels is disposed inside the base head and runs radially from the first flow channel.

4. The mirror according to claim 3, wherein
the fourth flow channel comprises a plurality of sub-fourth flow channels, and
the sub-second flow channels are in communication with the buffer tank portion via the respective sub-fourth flow channels.

5. The mirror according to claim 4, wherein a total cross-sectional area of the sub-second flow channels is smaller than a cross-sectional area of the buffer tank portion.

6. The mirror according to claim 4, wherein
the sub-second flow channels are in communication with an exterior of the mirror via the first flow channel, and
the buffer tank portion is in communication with the exterior of the mirror via the third flow channel.

7. The mirror according to claim 2, wherein the buffer tank portion is provided inside the base head.

8. The mirror according to claim 2, wherein the buffer tank portion is provided at a connection region between the base head and the support.

9. The mirror according to claim 2, wherein the buffer tank portion is provided inside the support.

10. The mirror according to claim 2, wherein the second flow channel is formed in a sectoral shape.

11. The mirror according to claim 10, wherein a cross-sectional area of the second flow channel is substantially uniform from one end to the other end.

12. A mirror device, comprising:
the mirror according to claim 1;
a pipe connected to the flow channel provided in the mirror;
a pressure-feed device provided on the pipe; and
a cooling device provided on the pipe.

13. A laser apparatus, comprising:
a master oscillator; and
an amplifier including the mirror according to claim 1.

14. The laser apparatus according to claim 13, further comprising a wavefront correction device.

15. An extreme ultraviolet light generation apparatus, comprising:
a chamber in which extreme ultraviolet light is generated;
a target supply unit, provided to the chamber, for supplying a target material to a region inside the chamber to generate the extreme ultraviolet light; and
or according to claim 1.
